(19) United States
(12) Patent Application Publication
(10) Pub. No.: US 2019/0025485 A1
(43) Pub. Date: Jan. 24, 2019

(54) PRESSURE-SENSITIVE-ADHESIVE-LAYER-ATTACHED ONE-SIDE-PROTECTED POLARIZING FILM, IMAGE DISPLAY DEVICE, AND METHOD FOR CONTINUOUSLY PRODUCING SAME

(71) Applicant: NITTO DENKO CORPORATION, Ibaraki-shi, Osaka (JP)

(72) Inventors: Satoshi Mita, Ibaraki-shi (JP); Tomonori Ueno, Ibaraki-shi (JP); Jingfan Xu, Ibaraki-shi (JP); Yusuke Motegi, Ibaraki-shi (JP); Atsushi Kishi, Ibaraki-shi (JP)

(73) Assignee: NITTO DENKO CORPORATION, Ibaraki-shi, Osaka (JP)

(21) Appl. No.: 16/070,082

(22) PCT Filed: Jan. 12, 2017
(86) PCT No.: PCT/JP2017/000847

§ 371 Date: Jul. 13, 2018

(30) Foreign Application Priority Data
Jan. 15, 2016 (JP) 2016-005934

(51) Int. Cl. G02B 5/30; B32B 7/12; B32B 27/30; B32B 27/18; C08L 29/04; C08K 3/38

(52) U.S. Cl. CPC G02B 5/305; B32B 7/12; B32B 27/306; B32B 27/18; B32B 2457/20; C08K 3/38; C08K 2003/387; B32B 2551/00; C08L 29/04

(57) ABSTRACT

This pressure-sensitive-adhesive-layer-attached one-side-protected polarizing film has a polarizer that contains a polyvinyl alcohol-based resin, contains 20 wt % or less of boric acid relative to the total quantity of the polarizer, has a thickness of 10 μm or less, and has prescribed optical characteristics. The film thickness of the pressure-sensitive adhesive layer is less than 50 μm, and if the storage elastic modulus of the pressure-sensitive adhesive layer at 23° C. is termed G (Pa) and the film thickness of the pressure-sensitive adhesive layer is termed H (μm), G>210e^{0.2035H} is satisfied when 50>H≥32, and G>35000e^{0.0433H} is satisfied when 32>H>0. In this pressure-sensitive-adhesive-layer-attached one-side-protected polarizing film, the polarizer has prescribed optical characteristics, and defects resulting from through cracks and nano-slits can be suppressed.

### TECHNICAL FIELD

The invention relates to a pressure-sensitive-adhesive-layer-attached one-side-protected polarizing film including a one-side-protected polarizing film having a polarizer and a protective film provided on only one surface of the polarizer and a pressure-sensitive adhesive layer. The pressure-sensitive-adhesive-layer-attached one-side-protected polarizing film may be used alone or as a component of a multilayer optical film to form an image display device such as a liquid crystal display (LCD) or an organic electroluminescent (EL) display.

### BACKGROUND ART

The image forming system of liquid crystal display devices has polarizing films placed as essential components on both sides of glass substrates that form the liquid crystal panel surfaces. A polarizing film generally used includes a polarizer and a protective film or films bonded to one or both surfaces of the polarizer with a polyvinyl alcohol-based adhesive or any other adhesive, in which the polarizer includes a polyvinyl alcohol-based film and a dichroic material such as iodine.

In general, a pressure-sensitive adhesive is used to bond such a polarizing film to a liquid crystal cell or any other component. The pressure-sensitive adhesive is provided as a pressure-sensitive adhesive layer in advance on one surface of the polarizing film because such a pressure-sensitive adhesive layer has advantages such as the ability to instantly fix the polarizing film and no need to perform a drying step for fixing the polarizing film. Thus, a pressure-sensitive-adhesive-layer-attached one-side-protected polarizing film is generally used when a polarizing film is bonded.

Polarizing films and pressure-sensitive-adhesive-layer-attached one-side-protected polarizing films have a problem in that in a harsh environment accompanied by thermal shock (e.g., a heat shock test in which −30° C. and 80° C. temperature conditions are repeated, or a test at a high temperature of 100° C.), the polarizer undergoes changes in shrinkage stress, so that cracks (through cracks) can easily occur entirely in the direction of the absorption axis of the polarizer. In other words, pressure-sensitive-adhesive-layer-attached one-side-protected polarizing films have insufficient durability to thermal shock in the harsh environment mentioned above. For thickness reduction, a pressure-sensitive-adhesive-layer-attached one-side-protected polarizing film can be produced using a one-side-protected polarizing film including a polarizer and a protective film provided on only one surface of the polarizer.

Particularly, such a pressure-sensitive-adhesive-layer-attached one-side-protected polarizing film has insufficient durability to the thermal shock mentioned above. In addition, the thermal shock-induced through cracks become more likely to occur as the size of the polarizing film increases.

For example, in order to impart high durability in a high-temperature environment, it has been proposed to use a pressure-sensitive adhesive layer having a storage elastic modulus of 0.2 to 10 MPa at 23° C. and a thickness of 2 μm or more and less than 25 μm in a pressure-sensitive-adhesive-layer-attached one-side-protected polarizing film (Patent Document 1). Also, in order to suppress occurrence of through cracks, a pressure-sensitive adhesive layer of a pressure-sensitive-adhesive-layer-attached one-side-protected polarizing film has been proposed for use, wherein shrinkage force in the direction orthogonal to the absorption axis of the polarizer is controlled to be small and the pressure-sensitive adhesive layer has a storage elastic modulus at 23° C. of 0.20 MPa or more (Patent Document 2). In addition, polarizers have also been reduced in thickness. For example, it is proposed to provide a thin polarizer having controlled optical properties including a controlled single-body transmittance and a controlled degree of polarization and also having high orientation (Patent Document 3).

### PRIOR ART DOCUMENTS

### Patent Documents

Patent Document 1: JP-A-2010-44211

Patent Document 2: JP-A-2013-72951

Patent Document 3: JP-B1-4751481

### SUMMARY OF THE INVENTION

### Problems to be Solved by the Invention

However, even though durability is satisfied in Patent Document 1, occurrence of through cracks due to shrinkage stress of the polarizer cannot be prevented because the thickness of the polarizer is as large as 25 μm. In Patent Documents 1 and 2, improvement of the durability of a pressure-sensitive-adhesive-layer-attached one-side-protected polarizing film is an object, so that boric acid used for the polarizer is relatively large. When the quantity of boric acid contained in the polarizer is larger than a specific numerical value, crosslinking by boric acid is accelerated upon heating to increase the shrinkage stress of the polarizer, so that such a case has been found to be not desirable from the viewpoint of suppressing occurrence of through cracks. That is, in Patent Documents 1 and 2, though through cracks can be prevented to some extent by controlling a storage elastic modulus of the pressure-sensitive adhesive layer, it cannot be said that occurrence of through cracks can be sufficiently suppressed.

On the other hand, polarizers have also been reduced in thickness. When a thinner polarizer is used to form a pressure-sensitive-adhesive-layer-attached one-side-protected polarizing film, changes in shrinkage stress in the polarizer become smaller. Therefore, it has been found that the use of a thinner polarizer makes it possible to suppress the occurrence of through cracks.

However, it has been found that even through the occurrence of through cracks is suppressed in a pressure-sensitive-adhesive-layer-attached one-side-protected polarizing film, extremely-fine partial cracks (hereafter also referred to as nano-slits) can occur in the absorption axis direction of the polarizer when the optical properties are controlled and the polarizer used is thin (e.g., 10 μm or less in thickness) as described in Patent Document 3, and mechanical shock is applied to the pressure-sensitive-adhesive-layer-attached one-side-protected polarizing film (including a case where a load is applied to the polarizer side by downward bending). It has also been found that the nano-slits can occur regardless of the polarizing film size. It has also been found that the nano-slits do not occur when a double-side-protected polarizing film is used, which includes a polarizer and protective films on both surfaces of the polarizer. It has also been found that when a through crack occurs in a polarizer, any other through crack will not occur adjacent to the through crack because the stress around the through crack is released, and that in contrast, not only a nano-slit can occur alone but also nano-slits can occur adjacent to each other. It has also been found that a through crack once formed in a polarizer has the ability to progressively extend in the absorption axis direction of the polarizer, and that in contrast, nano-slits have no ability to progressively extend. Thus, it has been found that the nano-slit is a new problem that occurs when a thin polarizer with optical properties controlled within specific ranges is used to form a one-side-protected polarizing film in which the occurrence of through cracks is suppressed, and that the nano-slit is a problem caused by a phenomenon different from that responsible for the through crack.

In addition, the nano-slits, which are extremely fine, cannot be detected in a normal environment. Therefore, even if nano-slits occur in a polarizer, light leakage defects in the pressure-sensitive-adhesive-layer-attached one-side-protected polarizing film produced therewith are difficult to find by only a glance. In other words, nano-slits are difficult to detect by automatic optical inspection, which is generally used for defect inspection of a one-side-protected polarizing film being produced in the form of a long strip. It has also been found that when pressure-sensitive-adhesive-layer-attached one-side-protected polarizing films are bonded to the glass substrates or other components of an image display panel and then placed in a heated environment, nano-slits can expand in the widthwise direction, so that nano-slit-induced defects can be detected (e.g., as the presence or absence of light leakage).

Therefore, it is desired to suppress defects resulting from not only through cracks but also nano-slits in a pressure-sensitive-adhesive-layer-attached one-side-protected polarizing film using a thin polarizer. Further, in the pressure-sensitive-adhesive-layer-attached one-side-protected polarizing film, since such a one-side-protected polarizing film is thinner compared with a polarizing film having protective films on both sides, the pressure-sensitive-adhesive-layer-attached one-side-protected polarizing film is likely to be bent or broken during handling.

The present invention relates to a pressure-sensitive-adhesive-layer-attached one-side-protected polarizing film including a one-side-protected polarizing film having a protective film on only one side of a thin polarizer and a pressure-sensitive adhesive layer. An object of the present invention is to provide a pressure-sensitive-adhesive-layer-attached one-side-protected polarizing film wherein the polarizer has prescribed optical characteristics, and defects resulting from through cracks and nano-slits can be suppressed.

It is a further object of the invention to provide an image display device having such a pressure-sensitive-adhesive-layer-attached one-side-protected polarizing film and to provide a method for continuously producing such an image display device.

### Means for Solving the Problems

As a result of intensive studies, the inventors have accomplished the invention based on findings that the problems can be solved by the pressure-sensitive-adhesive-layer-attached one-side-protected polarizing film, and other means described below.

That is, the present invention relates to a pressure-sensitive-adhesive-layer-attached one-side-protected polarizing film, which comprises a one-side-protected polarizing film having a protective film on only one side of a polarizer, and a pressure-sensitive adhesive layer on the polarizer side of the one-side-protected polarizing film, wherein

the polarizer comprises a polyvinyl alcohol-based resin, comprises 20% by weight or less of boric acid relative to a total quantity of the polarizer, has a thickness of 10 μm or less, and is designed to have a single-body transmittance T and a polarization degree P representing optical properties satisfying the condition of the following formula: P>−(10^{0.929T-42.4}−1)×100 (provided that T<42.3) or P≥99.9 (provided that T≥42.3),

a film thickness of the pressure-sensitive adhesive layer is less than 50 μm, and

if a storage elastic modulus of the pressure-sensitive adhesive layer at 23° C. is termed G (Pa) and a film thickness of the pressure-sensitive adhesive layer is termed H (Mm), G>210e^{0.2035}H is satisfied when 50>H≥32, and G>35000e^{0.0433}H is satisfied when 32>H>0.

In the pressure-sensitive-adhesive-layer-attached one-side-protected polarizing film, the film thickness H (m) preferably satisfies 32>H>0 and the storage elastic modulus G (Pa) preferably satisfies G>35000e^{0.0433H}.

In the pressure-sensitive-adhesive-layer-attached one-side-protected polarizing film, the pressure-sensitive adhesive layer preferably has a storage elastic modulus of 3.5×10⁴ Pa or more.

A separator may also be provided on the pressure-sensitive adhesive layer of the pressure-sensitive-adhesive-layer-attached one-side-protected polarizing film. The pressure-sensitive-adhesive-layer-attached one-side-protected polarizing film provided with the separator can be used in the form of a roll.

Further, the present invention relates to an image display device comprising the pressure-sensitive-adhesive-layer-attached one-side-protected polarizing film.

Further, the present invention relates to a method for continuously producing an image display device, the method comprising the steps of:

unwinding the pressure-sensitive-adhesive-layer-attached one-side-protected polarizing film from the roll of the pressure-sensitive-adhesive-layer-attached one-side-protected polarizing film;

feeding the pressure-sensitive-adhesive-layer-attached one-side-protected polarizing film with the separator; and

continuously bonding the pressure-sensitive-adhesive-layer-attached one-side-protected polarizing film to a surface of an image display panel with the pressure-sensitive adhesive layer interposed therebetween.

### Effect of the Invention

The pressure-sensitive-adhesive-layer-attached one-side-protected polarizing film of the present invention uses a polarizer having a thickness of 10 μm or less and is thinned. In addition, the thin polarizer having the thickness of 10 μm or less has less change in shrinkage stress applied to the polarizer due to thermal shock than when the polarizer has a large thickness, so that occurrence of through cracks can be suppressed.

On the other hand, nano-slits are more likely to occur in thin polarizers having specific optical characteristics. Nano-slits seem to occur when mechanical shock is applied to the pressure-sensitive-adhesive-layer-attached one-side-protected polarizing film, in the process of producing the one-side-protected polarizing film, in the process of producing the pressure-sensitive-adhesive-layer-attached one-side-protected polarizing film by forming a pressure-sensitive adhesive layer on the one-side-protected polarizing film, or in various processes after the production of the pressure-sensitive-adhesive-layer-attached one-side-protected polarizing film. Such nano-slits are assumed to be caused by a mechanism different from that responsible for through cracks caused by thermal shock. In addition, when the pressure-sensitive-adhesive-layer-attached one-side-protected polarizing films are bonded to a glass substrate of an image display panel and then placed in a heated environment, nano-slits expand in the widthwise direction, so that nano-slit-induced defects can be detected (e.g., as the presence or absence of light leakage).

In the pressure-sensitive-adhesive-layer-attached one-side-protected polarizing film of the present invention, a pressure-sensitive adhesive layer controlled so that the film thickness and the storage elastic modulus satisfy a prescribed relational expression is used in the pressure-sensitive adhesive layer having a thickness of less than 50 μm so that the pressure-sensitive adhesive layer becomes hard when the pressure-sensitive adhesive layer is thin. By using the pressure-sensitive adhesive layer adjusted in consideration of the film thickness and the storage elastic modulus as described above, even when a nano-slit is generated in the polarizer in the state of the one-side-protected polarizing film, it is possible to suppress the generation of defects due to nano-slits being expanded in the width direction.

As described above, by controlling the film thickness and the storage elastic modulus of the pressure-sensitive adhesive layer in the pressure-sensitive-adhesive-layer-attached one-side-protected polarizing film of the present invention, it is possible to suppress through cracks and defects due to the nano-slits occurring in the polarizer while satisfying thinning.

### BRIEF DESCRIPTION OF THE DRAWINGS

FIG. 1 is schematic cross-sectional view of example of the pressure-sensitive-adhesive-layer-attached one-side-protected polarizing film of the invention.

FIG. 2 is a graph showing the relationship between storage elastic modulus G (Pa) and film thickness H (μm) in the pressure-sensitive adhesive layer of the present invention.

FIGS. 3A and 3B are exemplary schematic diagrams for a comparison between a nano-slit and a through crack occurring in a polarizer.

FIGS. 4A to 4B are schematic views illustrating items to be evaluated for nano-slits in examples and comparative examples.

FIG. 5 is exemplary photograph showing whether crack is caused by nano-slit, for the evaluation of examples and comparative examples.

FIG. 6 is an exemplary photograph showing progress of a through crack for the evaluation of examples and comparative examples.

FIG. 7 is a schematic cross-sectional view of an example of a system for continuously producing image display devices.

### MODE FOR CARRYING OUT THE INVENTION

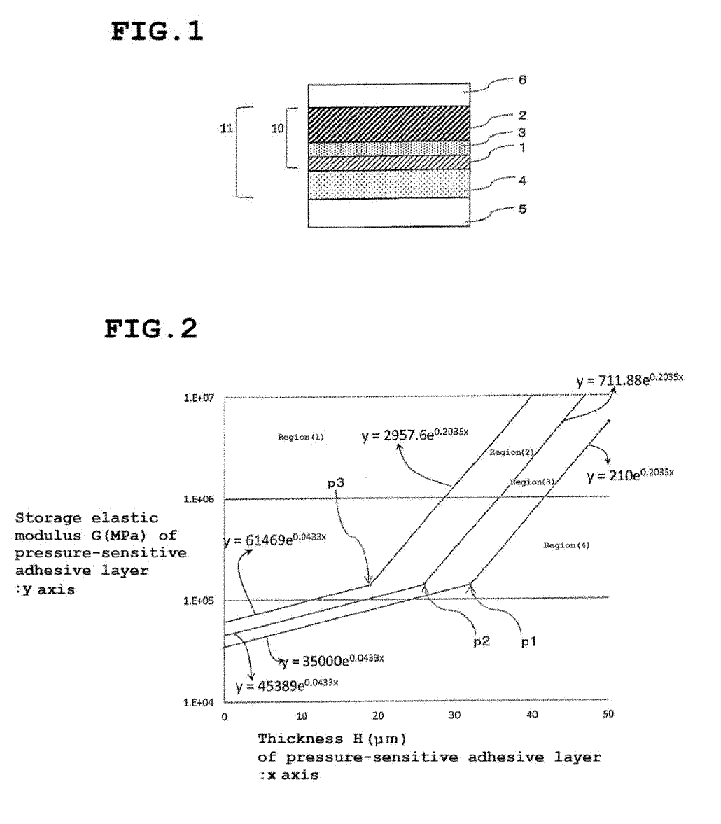

Hereinafter, the pressure-sensitive-adhesive-layer-attached one-side-protected polarizing film of the present invention will be described with reference to FIG. 1. A pressure-sensitive-adhesive-layer-attached one-side-protected polarizing film 11 of the present invention has, for example, a one-side-protected polarizing film 10 and a pressure-sensitive adhesive layer 4. As shown in FIG. 1, the one-side-protected polarizing film 10 has a protective film 2 on only one surface of a polarizer 1. The polarizer 1 and the protective film 2 are laminated with an adhesive layer 3 interposed therebetween (other interposed layers such as a pressure-sensitive adhesive layer, an undercoat layer (primer layer), etc.). Although not shown, in the one-side-protected polarizing films 10 and 10′, an easily adhesive layer or an activating treatment is provided on the protective film 2, so that the easily adhesive layer and the adhesive layer can be laminated. Although not shown, a plurality of the protective films 2 can be provided. The plurality of protective films 2 can be laminated with the adhesive layer 3 interposed therebetween (other interposed layers such as a pressure-sensitive adhesive layer, an undercoat layer (primer layer), etc.).

As shown in FIG. 1, a pressure-sensitive adhesive layer 4 in the pressure-sensitive-adhesive-layer-attached one-side-protected polarizing film 11 of the present invention is provided on the side of the polarizer 1 of the one-side-protected polarizing film 10. A separator 5 can be provided on the pressure-sensitive adhesive layer 4 of the pressure-sensitive-adhesive-layer-attached one-side-protected polarizing film 11 of the present invention, and a surface protective film 6 can be provided on the opposite side. FIG. 1 shows a case where both the separator 5 and the surface protective film 6 are provided in the pressure-sensitive-adhesive-layer-attached one-side-protected polarizing film 11. The pressure-sensitive-adhesive-layer-attached one-side-protected polarizing film 11 provided with at least the separator 5 (and optionally further provided with the surface protective film 6) may be used in the form of a roll. As will be described later, for example, a roll is advantageously used in a process that includes unwinding the pressure-sensitive-adhesive-layer-attached one-side-protected polarizing film 11 from the roll, feeding the film 11 on the separator 5, and bonding the film 11 to the surface of an image display panel with the pressure-sensitive adhesive layer 4 interposed therebetween (hereinafter, such a method will also be referred to as a “roll-to-panel process”, which is typically disclosed in JP-B1-4406043). The pressure-sensitive-adhesive-layer-attached one-side-protected polarizing film shown in FIG. 1 is preferably used from the viewpoints of suppression of the warpage of the display panel after bonding, and suppression of the occurrence of nano-slits.

As described above, the thickness of the pressure-sensitive adhesive layer is less than 50 μm, and the pressure-sensitive adhesive layer is designed to satisfy the following equations: when the storage elastic modulus of the pressure-sensitive adhesive layer at 23° C. is G(Pa) and the film thickness is H(μm), G>210e^{0.2035}H is satisfied when 50>H≥32, and G>35000e^{0.0433H} is satisfied when 32>H≥0. FIG. 2 shows a graph in which the storage elastic modulus: G(Pa) is expressed as the y axis and the film thickness: H(μm) as the x axis in the above equation. In the graph, straight lines showing the first relational expression of y=210e^{0.2035x}, y=35000e^{0.0433x} are shown with the boundary point p1 of the film thickness of 32 μm as a reference. Regions (1) to (3) in the graph are ranges that satisfy the first relational expression of the pressure-sensitive adhesive layer of the present invention. The region (4) is a range that does not satisfy the pressure-sensitive adhesive layer of the present invention. In the graph, some points are plotted for examples and comparative examples.

When the thickness of the pressure-sensitive adhesive layer is less than 45 μm, it is preferable to design the pressure-sensitive adhesive layer so as to satisfy G>711.9e^{0.2035}H when 45>H≥26, and G>45389e^{0.0433}H when of 26>H>0 from the viewpoint of suppressing the occurrence of nano-slits. In the graph of FIG. 2, straight lines showing the second relational expression of y=711.9e^{0.2035x}, y=45389e^{0.0433x} are shown with the boundary point p2 of the film thickness of 26 μm as a reference. Regions (2) to (3) in the graph are ranges that satisfy the second relational expression of the pressure-sensitive adhesive layer of the present invention.

Further, when the thickness of the pressure-sensitive adhesive layer is less than 40 μm, it is preferable to design the pressure-sensitive adhesive layer so as to satisfy G>2975.6e^{0.2035}H when 40>H≥26, and G>61469e^{0.0433H} when of 19>H>0 from the viewpoint of suppressing the occurrence of nano-slits. In the graph of FIG. 2, straight lines showing the third relational expression of y=2975.6e^{0.2035x}, y=61469e^{0.0433x} are shown with the boundary point p3 of the film thickness of 19 μm as a reference. The region (3) in the graph is a range that satisfies the third relational expression of the pressure-sensitive adhesive layer of the present invention.

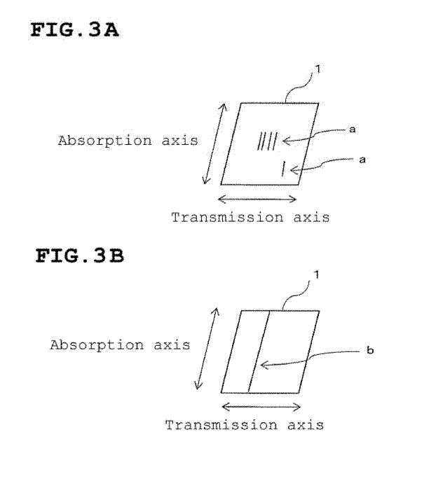

FIGS. 3A and 3B are schematic diagrams for comparing a nano-slit a and a through crack b, which can occur in the polarizer. FIG. 3A shows nano-slits a occurring in the polarizer 1, and FIG. 3B shows a through crack b occurring in the polarizer 1. The nano-slits a are caused by mechanical shock and partially occur in the direction of the absorption axis of the polarizer 1. The nano-slits a cannot be observed at the beginning of their formation, but become observable as they expand in the widthwise direction in a hot environment (e.g., at 80° C. or 60° C. and 90% RH). On the other hand, the nano-slits a are not considered to have the ability to progressively extend in the direction of the absorption axis of the polarizer. In addition, the nano-slits a are considered to occur regardless of the size of the polarizing film. Not only a single nano-slit a can occur alone, but also nano-slits a can occur adjacent to one another. On the other hand, the through crack b is caused by thermal shock (e.g., in a heat shock test). The through crack has the ability to progressively extend in the direction of the absorption axis of the polarizer, where the crack occurs. When a through crack b occurs, any other through crack will not occur adjacent thereto because the stress around it is released.

<Polarizer>

In the invention, the polarizer used has a thickness of 10 μm or less. In order to reduce the thickness and suppress the occurrence of through cracks, the thickness of the polarizer is preferably 8 μm or less, more preferably 7 μm or less, even more preferably 6 μm or less. On the other hand, the thickness of the polarizer is preferably 2 μm or more, more preferably 3 μm or more. The polarizer with such a small thickness is less uneven in thickness, has good visibility, and is less dimensionally-variable and thus has high durability to thermal shock.

The polarizer used includes a polyvinyl alcohol-based resin. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film, or may be a polyene-based oriented film such as a film of a dehydration product of polyvinyl alcohol or a dehydrochlorination product of polyvinyl chloride. Among these polarizers, a polarizer including a polyvinyl alcohol-based film and a dichroic material such as iodine is preferred.

For example, a polarizer including a uniaxially-stretched polyvinyl alcohol-based film dyed with iodine can be produced by a process including immersing a polyvinyl alcohol film in an aqueous iodine solution to dye the film and stretching the film to 3 to 7 times the original length. If necessary, the film may also be immersed in an aqueous solution of potassium iodide or the like optionally containing boric acid, zinc sulfate, zinc chloride, or other materials. If necessary, the polyvinyl alcohol-based film may be further immersed in water for washing before it is dyed. If the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

In view of stretching stability and optical durability, the polarizer can contain boric acid, but in the present invention, the content of boric acid contained in the polarizer is adjusted to 20% by weight or less relative to the total quantity of the polarizer from the viewpoint of suppressing the occurrence and expansion of through cracks and nano-slits. The content of boric acid contained in the polarizer is preferably 18% by weight or less, more preferably 16% by weight or less.

If the content of boric acid in the polarizer is more than 20% by weight, shrinkage stress in the polarizer can increase to make through cracks more likely to occur even when the thickness of the polarizer is controlled to 10 μm or less, which is not preferred. On the other hand, in view of the stretching stability and optical durability of the polarizer, the boron content is preferably 10% by weight or more, more preferably 12% by weight or more, based on the total weight of the polarizer.

Typical examples of the thin polarizer include the thin polarizers described in, for example, JP-B1-4751486, JP-B1-4751481, JP-B1-4815544, JP-B1-5048120, WO 2014/077599 A, and WO 2014/077636 A or thin polarizers obtained by the production methods described in these publications.

The polarizer is designed to have a single-body transmittance T and a polarization degree P that represent optical properties satisfying the condition of the following formula: P>−(10^{0.929T-42.4}−1)×100 (provided that T<42.3) or P≥99.9 (provided that T≥42.3). The polarizer designed to satisfy the condition uniquely has the performance required for a liquid crystal television display having a large display element. Specifically, such a display is required to have a contrast ratio of 1,000:1 or more and a maximum brightness of 500 cd/m² or more. In other applications, for example, the polarizer is bonded to the viewer side of an organic EL display device.

On the other hand, the polarizer designed to satisfy the condition includes a polymer (e.g., a polyvinyl alcohol-based molecule) having high orientation, which causes, together with the thickness of 10 μm or less, a significant reduction in the tensile rupture stress in the direction perpendicular to the absorption axis direction of the polarizer. This increases the possibility that nano-slits may occur in the direction of the absorption axis of the polarizer, for example, when the polarizer is exposed to mechanical shock beyond the tensile rupture stress in the process of producing the polarizing film. Therefore, the invention is particularly suitable for providing a one-side-protected polarizing film including the polarizer described above (or providing a pressure-sensitive-adhesive-layer-attached one-side-protected polarizing film including the polarizer described above).

The thin polarizer described above should be produced by a process capable of achieving high-ratio stretching to improve polarizing performance, among processes including the steps of stretching and dyeing a laminate. From this point of view, the thin polarizer is preferably obtained by a process including the step of stretching in an aqueous boric acid solution as described in JP-B1-4751486, JP-B1-4751481, or JP-B1-4815544, and more preferably obtained by a process including the step of performing auxiliary in-air stretching before stretching in an aqueous boric acid solution as described in JP-B1-4751481 or JP-B1-4815544. These thin polarizers can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage by stretching, because the layer is supported on the stretchable resin substrate.

<Protective Film>

The protective film is preferably made of a material having a high level of transparency, mechanical strength, thermal stability, water barrier properties, isotropy, and other properties. Examples of such a material include polyester-based polymers such as polyethylene terephthalate and polyethylene naphthalate, cellulose-based polymers such as diacetyl cellulose and triacetyl cellulose, acryl-based polymers such as polymethyl methacrylate, styrene-based polymers such as polystyrene and acrylonitrile-styrene copolymers (AS resins), and polycarbonate-based polymers. Examples of polymers that may be used to form the protective film also include polyolefin-based polymers such as polyethylene, polypropylene, cyclo-based or norbornene-structure-containing polyolefin, and ethylene-propylene copolymers, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, vinyl alcohol-based polymers, vinylidene chloride-based polymers, vinyl butyral-based polymers, arylate-based polymers, polyoxymethylene-based polymers, epoxy-based polymers, or any blends of the above polymers.

The protective film may also contain any type of one or more appropriate additives. Examples of such additives include ultraviolet absorbers, antioxidants, lubricants, plasticizers, release agents, discoloration preventing agents, flame retardants, nucleating agents, antistatic agents, pigments, and colorants. The content of the thermoplastic resin in the protective film is preferably from 50 to 100% by weight, more preferably from 50 to 99% by weight, even more preferably from 60 to 98% by weight, further more preferably from 70 to 97% by weight. If the content of the thermoplastic resin in the protective film is 50% by weight or less, high transparency and other properties inherent in the thermoplastic resin may fail to be sufficiently exhibited.

The protective film may also be, for example, a retardation film, a brightness enhancement film, or a diffusion film. The retardation film may have an in-plane retardation of 40 nm or more and/or a thickness direction retardation of 80 nm or more. The in-plane retardation is generally adjusted to fall within the range of 40 to 200 nm, and the thickness direction retardation is generally adjusted to fall within the range of 80 to 300 nm. When a retardation film is used as the protective film, the retardation film can also serve as a polarizer protecting film, which contributes to thickness reduction.

The retardation film may be a birefringent film formed by subjecting a thermoplastic resin film to uniaxial or biaxial stretching. The stretching temperature, the stretch ratio, and other conditions may be appropriately selected depending on the retardation value, the film material, and the thickness.

The thickness of the protective film may be selected as needed. In general, the thickness of the transparent protective film is from about 1 to about 500 μm in view of strength, workability such as handleability, and thin layer formability. In particular, the thickness of the transparent protective film is preferably from 1 to 300 μm, more preferably from 5 to 200 μm, even more preferably from 5 to 150 μm, further more preferably from 5 to 80 μm for thickness reduction.

The surface of the protective film, opposite to its surface where the polarizer is bonded, may be provided with a functional layer such as a hard coat layer, an anti-reflection layer, an anti-sticking layer, a diffusion layer, or an antiglare layer. The functional layer such as a hard coat layer, an anti-reflection layer, an anti-sticking layer, a diffusion layer, or an antiglare layer may be provided as part of the protective film itself or as a layer independent of the protective film.

<Intervening Layer>

The protective film and the polarizer are laminated with an intervening layer, such as an adhesive layer, a pressure-sensitive adhesive layer, or an undercoat layer (primer layer), between them. In this case, the intervening layer should preferably be used to laminate them with no air gap between them. It is preferable that the protective film and the polarizer are laminated with an adhesive layer interposed therebetween.

The adhesive layer is made from an adhesive. Any of various types of adhesives may be used. The adhesive layer may be of any optically-transparent type. The adhesive may be any of various types, such as a water-based adhesive, a solvent-based adhesive, a hot melt-based adhesive, and an active energy ray-curable adhesive. A water-based adhesive or an active energy ray-curable adhesive is preferred.

The water-based adhesive may be, for example, an isocyanate-based adhesive, a polyvinyl alcohol-based adhesive, a gelatin-based adhesive, a vinyl-based adhesive, a latex-based adhesive, or a water-based polyester adhesive. The water-based adhesive is generally used in the form of an aqueous solution, which generally has a solids content of 0.5 to 60% by weight.

The active energy ray-curable adhesive is an adhesive capable of being cured by exposure to active energy rays such as electron beams or ultraviolet rays (a radically or cationically curable adhesive). The active energy ray-curable adhesive to be used may be of, for example, an electron beam-curable type or an ultraviolet-curable type. The active energy ray-curable adhesive may be, for example, a photo-radically curable adhesive. The photo-radically curable type active energy ray-curable adhesive may be of an ultraviolet-curable type. In this case, the adhesive should contain a radically polymerizable compound and a photopolymerization initiator.

The method for applying the adhesive is appropriately selected depending on the viscosity of the adhesive and the desired thickness. Examples of application means include a reverse coater, a gravure coater (direct, reverse, or offset), a bar reverse coater, a roll coater, a die coater, a bar coater, and a rod coater. Any other suitable application method such as dipping may also be used.

For example, when the water-based adhesive is used, the adhesive is preferably applied in such a manner that the finally formed adhesive layer can have a thickness of 30 to 300 nm. The adhesive layer more preferably has a thickness of 60 to 250 nm. On the other hand, when the active energy ray-curable adhesive is used, the adhesive layer is preferably formed with a thickness of 0.1 to 200 μm. The thickness is more preferably from 0.5 to 50 μm, even more preferably from 0.5 to 10 μm.

In the process of laminating the polarizer and the protective film, an adhesion-facilitating layer may be placed between the protective film and the adhesive layer. The adhesion-facilitating layer may be made of, for example, any of various resins having a polyester skeleton, a polyether skeleton, a polycarbonate skeleton, a polyurethane skeleton, a silicone skeleton, a polyamide skeleton, a polyimide skeleton, a polyvinyl alcohol skeleton, or other polymer skeletons. These polymer resins may be used singly or in combination of two or more. Other additives may also be added to form the adhesion-facilitating layer. More specifically, a tackifier, an ultraviolet absorber, an antioxidant, or a stabilizer such as a heat-resistant stabilizer may also be used to form the adhesion-facilitating layer.

The adhesion-facilitating layer is usually provided in advance on the protective film, and then the adhesion-facilitating layer side of the protective film is bonded to the polarizer with the adhesive layer. The adhesion-facilitating layer can be formed using a known technique that includes applying an adhesion-facilitating-layer-forming material onto the protective film and drying the material. The adhesion-facilitating-layer-forming material is generally prepared in the form of a solution which is diluted to a suitable concentration taking into account the coating thickness after drying, the smoothness of the application, and other factors. After dried, the adhesion-facilitating layer preferably has a thickness of 0.01 to 5 μm, more preferably 0.02 to 2 μm, even more preferably 0.05 to 1 μm. Two or more adhesion-facilitating layers may be provided. Also in this case, the total thickness of the adhesion-facilitating layers preferably falls within these ranges.

The pressure-sensitive adhesive layer is made from a pressure-sensitive adhesive. Any of various pressure-sensitive adhesives may be used, examples of which include rubber-based pressure-sensitive adhesives, acryl-based pressure-sensitive adhesives, silicone-based pressure-sensitive adhesives, polyurethane-based pressure-sensitive adhesives, vinyl alkyl ether-based pressure-sensitive adhesives, polyvinylpyrrolidone-based pressure-sensitive adhesives, polyacrylamide-based pressure-sensitive adhesives, and cellulose-based pressure-sensitive adhesives. The base polymer with adhesive properties is selected depending on the type of the pressure-sensitive adhesive. Among these pressure-sensitive adhesive adhesives, acryl-based pressure-sensitive adhesives are preferably used because they have a high level of optical transparency, weather resistance, heat resistance, and other properties, and exhibit an appropriate level of wettability and adhesive properties including cohesiveness and adhesiveness.

The undercoat layer (primer layer) is formed to improve the adhesion between the polarizer and the protective film. The primer layer may be made of any material capable of providing somewhat strong adhesion to both the base film and a polyvinyl alcohol-based resin layer. For example, a thermoplastic resin having a high level of transparency, thermal stability, and stretchability may be used to form the primer layer. Such a thermoplastic resin may be, for example, an acryl-based resin, a polyolefin-based resin, a polyester-based resin, a polyvinyl alcohol-based resin, or any mixture thereof.

<Pressure-Sensitive Adhesive Layer>

As described above, the pressure-sensitive adhesive layer in the pressure-sensitive-adhesive-layer-attached one-side-protected polarizing film of the present invention is controlled so that the film thickness and the storage elastic modulus satisfy the above equation. The thickness of the pressure-sensitive adhesive layer is less than 50 μm. From the viewpoint of reworkability and heating durability (suppression of peeling upon heating), it is preferable that the pressure-sensitive adhesive layer is soft, and the film thickness of the pressure-sensitive adhesive layer is preferably, for example, 30 μm or less, more preferably 25 μm or less. The film thickness of the pressure-sensitive adhesive layer is preferably 1 μm or more, more preferably 5 μm or more, from the viewpoint of suppressing peeling. Further, from the viewpoint of suppressing defects due to foreign matter biting when the pressure-sensitive adhesive layer is stuck to a panel or the like, it is preferable that the pressure-sensitive adhesive layer is thick, for example, 10 pn or more in thickness, more preferably 15 μm or more in thickness.

In addition, as can be seen from the graph of FIG. 2, it is preferred that the storage elastic modulus at 23° C. of the pressure-sensitive adhesive layer is 3.5×10⁴ Pa or more because the pressure-sensitive-adhesive-layer-attached one-side-protected polarizing film prevents the load caused by convex folds on the polarizer side, thereby securing crack resistance (suppression of occurrence of nano-slits). Further, the storage elastic modulus of the pressure-sensitive adhesive layer is preferably 1.0×10⁵ Pa or more. On the other hand, when the storage elastic modulus of the pressure-sensitive adhesive layer is increased, the pressure-sensitive adhesive layer tends to be too hard, so that the reworkability tends to deteriorate. Therefore, the storage elastic modulus of the pressure-sensitive adhesive layer is preferably 1×10⁸ Pa or less, more preferably 1×10⁷ Pa or less, even more preferably 1×10⁶ Pa or less.

The pressure-sensitive adhesive layer may be formed using any appropriate type of pressure-sensitive adhesive. Examples of the pressure-sensitive adhesive include a rubber-based pressure-sensitive adhesive, an acryl-based pressure-sensitive adhesive, a silicone-based pressure-sensitive adhesive, a urethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, and a cellulose-based pressure-sensitive adhesive.

Among these pressure-sensitive adhesives, those having a high level of optical transparency and weather resistance or heat resistance and exhibiting an appropriate level of wettability and adhesive properties such as cohesiveness and adhesiveness are preferably used. An acryl-based pressure-sensitive adhesive is preferably used because it has such properties.

As the acryl-based pressure-sensitive adhesive, an acryl-based polymer as a base polymer comprising a monomer unit of alkyl (meth)acrylate as a main skeleton can be used. Note here that (meth)acrylate, which refers to acrylate and/or methacrylate, is similar in meaning to (meth) of the present invention.

The alkyl group of the alkyl (meth)acrylate constituting the main skeleton of the acryl-based polymer has about 1 to 14 carbon atoms, and specific examples of the alkyl (meth)acrylate include methyl (meth)acrylate, ethyl (meth)acrylate, propyl (meth)acrylate, isopropyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, dodecyl (meth)acrylate, stearyl (meth)acrylate, and the like. These may be used singly or in combination thereof. Among these, an alkyl (meth)acrylate having an alkyl group of 1 to 9 carbon atoms is preferable.

One or more kinds of various monomers can be introduced into the acryl-based polymer by copolymerization for the purpose of improving adhesiveness and heat resistance. Specific examples of such a copolymerizable monomer include a carboxyl group-containing monomer, a hydroxyl group-containing monomer, a nitrogen-containing monomer (including a heterocyclic group-containing monomer), and an aromatic group-containing monomer.

Examples of the carboxyl group-containing monomer include acrylic acid, methacrylic acid, carboxyethyl (meth)acrylate, carboxypentyl (meth)acrylate, itaconic acid, maleic acid, fumaric acid, crotonic acid, and the like. Of these, acrylic acid and methacrylic acid are preferable.

As the hydroxyl group-containing monomer, there are exemplified 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate.

Examples of the nitrogen-containing monomer, as monomer examples for modification, include maleimide, N-cyclohexylmaleimide, N-phenylmaleimide; N-acryloylmorpholine; (N-substituted)amide-type monomers, such as (meth)acrylamide, N,N-dimethyl (meth)acrylamide, N,N-diethyl (meth)acrylamide, N-hexyl (meth)acrylamide, N-methyl (meth)acrylamide, N-butyl (meth)acrylamide, N-butyl (meth)acrylamide, N-methylol (meth)acrylamide, and N-methylolpropane (meth)acrylamide; alkylaminoalkyl (meth)acrylate-type monomers, such as aminoethyl (meth)acrylate, aminopropyl (meth)acrylate, N,N-dimethylaminoethyl (meth)acrylate, t-butylaminoethyl (meth)acrylate, and 3-(3-pyridinyl)propyl (meth)acrylate; alkoxyalkyl (meth)acrylate-type monomers, such as methoxyethyl (meth)acrylate and ethoxyethyl (meta)acrylate; succineimide-type monomers, such as N-(meth)acryloyloxymethylene succinimide, N-(meth)acryloyl-6-oxyhexamethylenesuccinimide, N-(meth)acryloyl-8-oxyoctamethylenesuccinimide, and N-acryloylmorpholine.

Examples of the aromatic-containing monomer include benzyl (meth)acrylate, phenyl (meth)acrylate, phenoxyethyl (meth)acrylate, and the like.

In addition to the above monomers, there are exemplified acid anhydride group-containing monomers such as maleic anhydride and itaconic anhydride; caprolactone adduct of acrylic acid; sulfonic acid group-containing monomers such as styrene sulfonic acid, allylsulfonic acid, 2-(meth)acrylamido-2-methylpropanesulfonic acid, (meth)acrylamidopropane sulfonic acid, sulfopropyl (meth)acrylate, and (meth)acryloyloxynaphthalene sulfonic acid; and phosphoric acid group-containing monomers such as 2-hydroxyethylacryloylphosphate.

It is also possible to use vinyl-type monomers, such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate-type monomers, such as acrylonitrile and methacrylonitrile; epoxy group-containing acrylic monomers, such as glycidyl (meth)acrylate; glycol-type acrylic acid ester monomers, such as polyethylene glycol (meth)acrylate, polypropylene glycol (meth)acrylate, methoxyethylene glycol (meth)acrylate, methoxypolypropylene glycol (meth)acrylate; acrylic acid ester-type monomers, such as tetrahydrofurfuryl (meth)acrylate, fluorinated (meth)acrylate, silicone (meth)acrylate, and 2-methoxyethyl (meth)acrylate, and the like.

When the pressure-sensitive adhesive layer is formed with an acryl-based pressure-sensitive adhesive, examples of the copolymerizable monomer to be combined with an alkyl (meth)acrylate having an alkyl group of 1 to 9 carbon atoms as a monomer constituting the main skeleton of the acryl-based polymer include preferably a hydroxyl group-containing monomer.

For example, it is preferable to use butyl (meth)acrylate as the monomer constituting the main skeleton and 2-hydroxyethyl (meth)acrylate as the hydroxyl group-containing monomer, from the viewpoint of decreasing the storage elastic modulus at 120° C. of the pressure-sensitive adhesive layer.

Among them, hydroxyl group-containing monomers are preferably used from the viewpoint of good reactivity with the crosslinking agent. Further, from the viewpoint of adhesiveness and adhesion durability, a carboxyl group-containing monomer such as acrylic acid is preferably used.

The proportion in weight ratio of the copolymerizable monomer in the acryl-based polymer is not particularly limited but is 50% by weight or less. Such proportion is preferably 0.1 to 10% by weight, more preferably 0.5 to 8% by weight, even more preferably 1 to 6% by weight.

The average molecular weight of the acryl-based polymer is not particularly limited, but the weight average molecular weight is preferably about 300,000 to 2,500,000. Production of the acryl-based polymer can be carried out by various known methods. For example, radical polymerization methods such as bulk polymerization method, solution polymerization method, suspension polymerization method, and the like can be appropriately selected. As the radical polymerization initiator, various known azo type initiators, peroxide type initiators, etc. can be used. The reaction temperature is usually about 50 to 80° C., and the reaction time is 1 to 8 hours. Among the above production methods, the solution polymerization method is preferable, and ethyl acetate, toluene, etc. are generally used as the solvent for the acryl-based polymer.

The acryl-based polymer can be blended with a crosslinking agent. Adhesiveness and durability can be improved by the crosslinking agent, and reliability at high temperature and shape of the pressure-sensitive adhesive itself can be maintained. As the crosslinking agent, an isocyanate type, an epoxy type, a peroxide type, a metal chelate type, an oxazoline type, and the like can be appropriately used. These crosslinking agents can be used singly or in combination of two or more kinds thereof.

The isocyanate compounds are used as the isocyanate crosslinking agents. Examples of such isocyanate compounds include isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate, and hydrogenated diphenylmethane diisocyanate, and adduct type isocyanate compounds produced by adding the isocyanate monomer to trimethylolpropane or the like; and urethane prepolymer type isocyanates produced by the addition reaction of isocyanurate compounds, burette type compounds, and further known polyether polyols or polyester polyols, acrylic polyols, polybutadiene polyols, polyisoprene polyols, or the like.

The isocyanate crosslinking agents may be used singly or in combination of two or more kinds thereof, but the total content of the crosslinking agent is preferably within a range of 0.01 to 2 parts by weight of the polyisocyanate compound as the crosslinking agent, more preferably within a range of 0.02 to 2 parts by weight, even more preferably within a range of 0.05 to 1.5 parts by weight, relative to 100 parts by weight of the (meth)acryl-based polymer (A). In consideration of cohesive force, peeling prevention in durability test, etc., it is possible to appropriately contain the isocyanate crosslinking agent.

Various types of peroxides may be used as the peroxide crosslinking agent. Examples of such peroxides include di(2-ethylhexyl) peroxydicarbonate, di(4-tert-butylcyclohexyl) peroxydicarbonate, di-sec-butyl peroxydicarbonate, tert-butyl peroxyneodecanoate, tert-hexyl peroxypivalate, tert-butyl peroxypivalate, dilauroyl peroxide, di-n-octanoyl peroxide, 1,1,3,3-tetramethylbutyl peroxyisobutylate, 1,1,3,3-tetramethylbutyl peroxy-2-ethyl hexanoate, di(4-methylbenzoyl) peroxide, dibenzoyl peroxide, and tert-butyl peroxyisobutylate. Of these, di(4-tert-butylcyclohexyl) peroxydicarbonate, dilauroyl peroxide, and dibenzoyl peroxide are preferably used, because their crosslinking reaction efficiency is particularly good.

The peroxides may be used singly or in combination of two or more kinds thereof, but the total content of the peroxide is 0.01 to 2 parts by weight, preferably 0.04 to 1.5 parts by weight, more preferably 0.05 to 1 part by weight, relative to 100 parts by weight of the (meth)acryl-based polymer (A). In order to adjust processability, reworkability, crosslinking stability, releasability, etc., the peroxide is appropriately selected within the above range.

Further, the pressure-sensitive adhesive can contain a silane coupling agent. By using a silane coupling agent, durability can be improved. Silane coupling agents having any appropriate functional group can be used. Specifically, examples of such a functional group include vinyl, epoxy, amino, mercapto, (meth)acryloxy, acetoacetyl, isocyanate, styryl, and polysulfide groups. Specific examples of the silane coupling agent include a vinyl group-containing silane coupling agent such as vinyltriethoxysilane, vinyltripropoxysilane, vinyltriisopropoxysilane, and vinyltributoxysilane; an epoxy group-containing silane coupling agent such as γ-glycidoxypropyltrimethoxysilane, γ-glycidoxypropyltriethoxysilane, 3-glycidoxypropylmethyldiethoxysilane, and 2-(3,4-epoxycyclohexyl)ethyltrimethoxysilane; an amino group-containing silane coupling agent such as γ-aminopropyltrimethoxysilane, N-n-(aminoethyl)-γ-aminopropylmethyldimethoxysilane, N-(2-aminoethyl)3-aminopropylmethyldimethoxysilane, γ-triethoxysilyl-N-(1,3-dimethylbutylidene)propylamine, and N-phenyl-γ-aminopropyltrimethoxysilane; a mercapto group-containing silane coupling agent such as γ-mercaptopropylmethyldimethoxysilane; a styryl group-containing silane coupling agent such as p-styryltrimethoxysilane; a (meth)acrylic group-containing silane coupling agent such as γ-acryloxypropyltrimethoxysilane and γ-methacryloxypropyltriethoxysilane; an isocyanate group-containing silane coupling agent such as 3-isocyanatopropyltriethoxysilane; and a polysulfide group-containing silane coupling agent such as bis(triethoxysilylpropyl)tetrasulfide, and the like.

The silane coupling agent may be used singly or as a mixture of two or more of them, but the total content of the silane coupling agent is preferably 0.001 to 5 parts by weight, more preferably 0.01 to 1 part by weight, even more preferably 0.02 to 1 part by weight, still even more preferably 0.05 to 0.6 parts by weight, relative to 100 parts by weight of the acryl-based polymer.

As a method of forming the pressure-sensitive adhesive layer, for example, there is exemplified a method in which the pressure-sensitive adhesive is applied to a release-treated separator or the like and the polymerization solvent or the like is removed by drying to form a pressure-sensitive adhesive layer, which is transferred to the polarizer side (polarizer in the embodiment of FIG. 1) of the one-side-protected polarizing film, or a method in which the pressure-sensitive adhesive is applied and the polymerization solvent or the like is removed by drying to form a pressure-sensitive adhesive layer on the polarizer side, or the like. In applying the pressure-sensitive adhesive, one or more solvents other than the polymerization solvent may be newly added as appropriate.

A silicone release liner is preferably used as the release-treated separator. In the invention, the pressure-sensitive adhesive may be applied to such a liner and then dried to form a pressure-sensitive adhesive layer. In this process, any appropriate method may be used for drying the pressure-sensitive adhesive, depending on purpose.

Preferably, a method of heating and drying the coating film is used. The heating and drying temperature is preferably from 40° C. to 200° C., more preferably from 50° C. to 180° C., even more preferably from 70° C. to 170° C. When the heating temperature is set in the range, a pressure-sensitive adhesive with a high level of adhesive properties can be obtained.

Any appropriate drying time may be used as needed. The drying time is preferably from 5 seconds to 20 minutes, more preferably from 5 seconds to 10 minutes, even more preferably from 10 seconds to 5 minutes.

Various methods may be used to form the pressure-sensitive adhesive layer. Examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or other means.

When the pressure-sensitive adhesive layer is exposed, the pressure-sensitive adhesive layer may be protected by a release-treated sheet (separator) until it is actually used.

Examples of the material used to form such a separator include a plastic film such as a polyethylene, polypropylene, polyethylene terephthalate, or polyester film, a paper, a cloth, a porous material such as nonwoven fabric, and appropriate thin materials such as a net, a foamed sheet, a metal foil, and any laminate thereof. A plastic film is preferably used because of its good surface smoothness.

Such a plastic film may be of any type capable of protecting the pressure-sensitive adhesive layer. Such a plastic film may be, for example, a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The separator generally has a thickness of about 5 to about 200 μm, preferably about 5 to about 100 μm. If necessary, the separator may be subjected to a release treatment and an anti-pollution treatment with a silicone-based, fluoride-based, long-chain alkyl-based, or fatty acid amide-based release agent, a silica powder, or other materials, or subjected to an antistatic treatment of coating type, kneading and mixing type, vapor-deposition type, or other types. In particular, when the surface of the separator is appropriately subjected to a release treatment such as a silicone treatment, a long-chain alkyl treatment, or a fluorine treatment, the releasability from the pressure-sensitive adhesive layer can be further improved.

<Surface Protective Film>

A surface protective film may be provided on the pressure-sensitive-adhesive-layer-attached one-side-protected polarizing film. The surface protective film generally has a base film and a pressure-sensitive adhesive layer. The surface protective film protects the polarizer with the pressure-sensitive adhesive layer interposed between them.

In view of the ability to be tested or managed, an isotropic or nearly-isotropic film material should be selected as the base film for the surface protective film. Examples of such a film material include polyester-based resins such as polyethylene terephthalate films, cellulose-based resins, acetate-based resins, polyethersulfone-based resins, polycarbonate-based resins, polyamide-based resins, polyimide-based resins, polyolefin-based resins, acryl-based resins, and other transparent polymers. In particular, polyester-based resins are preferred. The base film may be made of a single film material or a laminate of two or more film materials. The base film may also be a product obtained by stretching the film. The base film generally has a thickness of 500 μm or less, preferably 10 to 200 μm.

The pressure-sensitive adhesive used to form the pressure-sensitive adhesive layer for the surface protective film may be appropriately selected from pressure-sensitive adhesives including, as a base polymer, a (meth)acryl-based polymer, a silicone-based polymer, polyester, polyurethane, polyamide, polyether, fluoride-based polymer, rubber-based polymer, or any other polymer. An acrylic pressure-sensitive adhesive containing an acryl-based polymer as a base polymer is preferred in view of transparency, weather resistance, heat resistance, and other properties. The thickness (dry thickness) of the pressure-sensitive adhesive layer is selected depending on the desired adhesive strength. The thickness of the pressure-sensitive adhesive is generally from about 1 to about 100 μm, preferably from 5 to 50 μm.

A silicone, long-chain alkyl, or fluorine treatment with a low-adhesion material may also be performed to form a release treatment layer on the surface of the base film of the surface protective film, opposite to its surface on which the pressure-sensitive adhesive layer is provided.

<Other Optical Layers>

For practical use, the pressure-sensitive-adhesive-layer-attached one-side-protected polarizing film of the invention may be laminated with any other optical layer or layers to form an optical film. As a non-limiting example, such an optical layer or layers may be one or more optical layers that have ever been used to form liquid crystal display devices or other devices, such as a reflector, a transflector, a retardation plate (including a wavelength plate such as a half or quarter wavelength plate), or a viewing angle compensation film. Particularly preferred is a reflective or transflective polarizing film including a laminate of the pressure-sensitive-adhesive-layer-attached one-side-protected polarizing film of the invention and a reflector or a transflector, an elliptically or circularly polarizing film including a laminate of the pressure-sensitive-adhesive-layer-attached one-side-protected polarizing film of the invention and a retardation plate, a wide viewing angle polarizing film including a laminate of the pressure-sensitive-adhesive-layer-attached one-side-protected polarizing film of the invention and a viewing angle compensation film, or a polarizing film including a laminate of the pressure-sensitive-adhesive-layer-attached one-side-protected polarizing film of the invention and a brightness enhancement film.

The optical film including a laminate of the above optical layer and the pressure-sensitive-adhesive-layer-attached one-side-protected polarizing film may be formed by a method of stacking them one by one, for example, in the process of manufacturing a liquid crystal display device. However, the optical film should be formed by stacking them in advance, which is superior in quality stability or assembling workability and thus advantageous in facilitating the process of manufacturing liquid crystal display devices or other devices. In the lamination, any appropriate bonding means such as a pressure-sensitive adhesive layer may be used. When the pressure-sensitive-adhesive-layer-attached one-side-protected polarizing film and any other optical film are bonded together, their optical axes may be each aligned at an appropriate angle, depending on the desired retardation properties or other desired properties.

The pressure-sensitive-adhesive-layer-attached one-side-protected polarizing film, or the optical film according to the invention is preferably used to form various image display devices such as liquid crystal display devices and organic EL display devices. Liquid crystal display devices may be formed according to conventional techniques. Specifically, a liquid crystal display device may be typically formed according to any conventional techniques by appropriately assembling a liquid crystal cell, pressure-sensitive-adhesive-layer-attached one-side-protected polarizing films or optical films, and optional components such as a lighting system, incorporating a driving circuit, and performing other processes, except that the pressure-sensitive-adhesive-layer-attached one-side-protected polarizing film, or the optical film according to the invention is used. The liquid crystal cell to be used may also be of any type, such as IPS type or VA type. The invention is particularly suitable for IPS type.

Any desired liquid crystal display device may be formed, such as a liquid crystal display device including a liquid crystal cell and the pressure-sensitive-adhesive-layer-attached one-side-protected polarizing film or films, or the optical film or films placed on one or both sides of the liquid crystal cell, or a liquid crystal display device further including a backlight or a reflector in the lighting system. In such a case, the pressure-sensitive-adhesive-layer-attached one-side-protected polarizing film or films or the optical film or films according to the invention may be placed on one or both sides of the liquid crystal cell. When the pressure-sensitive-adhesive-layer-attached one-side-protected polarizing films, or the optical films are provided on both sides, they may be the same or different. The process of forming the liquid crystal display device may also include placing, at an appropriate position or positions, one or more layers of an appropriate component such as a diffusion plate, an antiglare layer, an anti-reflection film, a protective plate, a prism array, a lens array sheet, a light diffusion plate, or a backlight.

<Method for Continuously Producing Image Display Device>

The image display device described above is preferably produced by a continuous production method (roll-to-panel process) including the steps of: unwinding the pressure-sensitive-adhesive-layer-attached one-side-protected polarizing film of the invention from a roll thereof; feeding the pressure-sensitive-adhesive-layer-attached one-side-protected polarizing film with the separator; and continuously bonding the pressure-sensitive-adhesive-layer-attached one-side-protected polarizing film to the surface of an image display panel with the pressure-sensitive adhesive layer interposed therebetween. The pressure-sensitive-adhesive-layer-attached one-side-protected polarizing film of the invention is a very thin film. Therefore, if the pressure-sensitive-adhesive-layer-attached one-side-protected polarizing film of the invention is subjected to a process that includes cutting the film into sheet pieces (cut pieces) and then bonding the pieces one by one to image display panels (also referred to as a “sheet-to-panel process”), the sheets will be difficult to feed or handle during the bonding of them to the display panels, so that the risk for the pressure-sensitive-adhesive-layer-attached one-side-protected polarizing films (sheets) to undergo high mechanical shock (such as suction-induced bending) will increase during these processes. In order to reduce the risk, other measures should be taken, such as using a relatively thick surface protective film including a base film with a thickness of 50 μm or more. In contrast, the roll-to-panel process allows the pressure-sensitive-adhesive-layer-attached one-side-protected polarizing film to be stably fed from the roll to the image display panel with the aid of the separator, without cutting the film into sheet pieces (cut pieces), and also allows the film to be directly bonded to the image display panel, which makes it possible to significantly reduce the risk without using a relatively thick surface protective film. As a result, in combination with the ability to alleviate the mechanical shock by the pressure-sensitive adhesive layer controlled so that the film thickness and storage elastic modulus satisfy the prescribed relational expression, an image display panel in which occurrence of nano-slits is effectively suppressed can be continuously produced at a high speed.

FIG. 7 is a schematic diagram illustrating an example of a system for continuously producing liquid crystal devices using the roll-to-panel process.

As illustrated in FIG. 7, a system 100 for continuously producing liquid crystal display devices includes a continuous feed unit X configured to feed liquid crystal display panels P, a first polarizing film supply unit 101a, a first bonding unit 201a, a second polarizing film supply unit 101b, and a second bonding unit 201b.

In this case, a roll 20a of a first pressure-sensitive-adhesive-layer-attached one-side-protected polarizing film (a first roll) and a roll 20b of a second pressure-sensitive-adhesive-layer-attached one-side-protected polarizing film (a second roll) are used, in which the films each have an absorption axis in the longitudinal direction and each have the structure shown in FIG. 2A.

(Feed Unit)

The feed unit X is configured to feed liquid crystal display panels P. The feed unit X includes a plurality of feed rollers, suction plates, and other components. The feed unit X includes an orientation changing unit 300 that is provided between the first and second bonding units 201a and 201b and configured to interchange the positional relationship between the long and short sides of the liquid crystal panel P with respect to the direction of the feed of the liquid crystal display panel P (e.g., by horizontally turning the liquid crystal display panel P by 90°). This allows the first and second pressure-sensitive-adhesive-layer-attached one-side-protected polarizing films 21a and 21b to be bonded in a cross-Nicols relationship to the liquid crystal display panel P.

(First Polarizing Film Supply Unit)

The first polarizing film supply unit 101a is configured to unwind the first pressure-sensitive-adhesive-layer-attached one-side-protected polarizing film 21a (with a surface protective film) from the first roll 20a, feed the film 21a with the separator 5a, and continuously supply the film 21a to the first bonding unit 201a. The first polarizing film supply unit 101a includes a first unwinding unit 151a, a first cutting unit 152a, a first peeling unit 153a, a first winding unit 154a, a plurality of feed roller units, an accumulator unit including dancer rolls, and other components.

The first unwinding unit 151a has an unwinding shaft on which the first roll 20a is placed, and is configured to unwind, from the first roll 20a, the long, pressure-sensitive-adhesive-layer-attached one-side-protected polarizing film 21a provided with the separator 5a.

The first cutting unit 152a includes cutting means such as a cutter or a laser and suction means. The first cutting unit 152a is configured to form a piece with a predetermined length by transversely cutting the first long pressure-sensitive-adhesive-layer-attached one-side-protected polarizing film 21a and leaving the separator 5a uncut. Alternatively, the first roll 20a may be a roll of a laminate of the separator 5a and the long pressure-sensitive-adhesive-layer-attached one-side-protected polarizing film 21a with a plurality of score lines formed in the widthwise direction at predetermined intervals (a scored optical film roll). In this case, the first cutting unit 152a is unnecessary (this also applies to the second cutting unit 152b described below).

The first peeling unit 153a is configured to peel off the first pressure-sensitive-adhesive-layer-attached one-side-protected polarizing film 21a from the separator 5a by inwardly folding back the separator 5a. The first peeling unit 153a may include a wedge-shaped member, rollers, and other components.

The first winding unit 154a is configured to wind the separator 5a from which the first pressure-sensitive-adhesive-layer-attached one-side-protected polarizing film 21a has been peeled off. The first winding unit 154a has a winding shaft on which a roll for winding the separator 5a is placed.

(First Bonding Unit)

The first bonding unit 201a is configured to continuously bond the first pressure-sensitive-adhesive-layer-attached one-side-protected polarizing film 21a, which has been peeled off by the first peeling unit 153a, to the liquid crystal display panel P, which is being fed by the feed unit X, with the pressure-sensitive adhesive layer of the first pressure-sensitive-adhesive-layer-attached one-side-protected polarizing film 21a interposed therebetween (first bonding step). The first bonding unit 81 includes a pair of bonding rollers, at least one of which includes a drive roller.

(Second Polarizing Film Supply Unit)

The second polarizing film supply unit 101b is configured to unwind the second pressure-sensitive-adhesive-layer-attached one-side-protected polarizing film 21b (with a surface protective film) from the second roll 20b, feed the film 21b with the separator 5b, and continuously supply the film 21b to the second bonding unit 201b. The second polarizing film supply unit 101b includes a second unwinding unit 151b, a second cutting unit 152b, a second peeling unit 153b, a second winding unit 154b, a plurality of feed roller units, an accumulator unit including dancer rolls, and other components. The second unwinding unit 151b, the second cutting unit 152b, the second peeling unit 153b, and the second winding unit 154b have the same structures and functions as those of the first unwinding unit 151a, the first cutting unit 152a, the first peeling unit 153a, and the first winding unit 154a, respectively.

(Second Bonding Unit)

The second bonding unit 201b is configured to continuously bond the second pressure-sensitive-adhesive-layer-attached one-side-protected polarizing film 21b, which has been peeled off by the second peeling unit 153b, to the liquid crystal display panel P, which is being fed by the feed unit X, with the pressure-sensitive adhesive layer of the second pressure-sensitive-adhesive-layer-attached one-side-protected polarizing film 21b interposed therebetween (second bonding step). The second bonding unit 201b includes a pair of bonding rollers, at least one of which includes a drive roller (second bonding step).

### EXAMPLES

Hereinafter, the invention will be more specifically described with reference to examples. It will be understood that the examples shown below are not intended to limit the invention. In each example, “parts” and “%” are all by weight. Unless otherwise specified below, the conditions of standing at room temperature include 23° C. and 65% RH in all cases.

<Preparation of Polarizer>

(Preparation of Polarizer A0)

A corona treatment was performed on one surface of an amorphous isophthalic acid-copolymerized polyethylene terephthalate (IPA-copolymerized PET) film substrate (100 μm in thickness) with a water absorption of 0.75% and a Tg of 75° C. An aqueous solution containing polyvinyl alcohol (4,200 in polymerization degree, 99.2% by mole in saponification degree) and acetoacetyl-modified PVA (Gohsefimer Z200 (trade name) manufactured by The Nippon Synthetic Chemical Industry Co., Ltd., 1,200 in polymerization degree, 4.6% in acetoacetyl modification degree, 99.0% by mole or more in saponification degree) in a ratio of 9:1 was applied to the corona-treated surface at 25° C. and then dried to form a 11-μm-thick PVA-based resin layer, so that a laminate was formed.

In an oven at 120° C., the resulting laminate was subjected to free-end uniaxial stretching to 2.0 times in the longitudinal direction between rolls at different peripheral speeds (auxiliary in-air stretching).

Subsequently, the laminate was immersed in an insolubilization bath (an aqueous boric acid solution obtained by adding 4 parts by weight of boric acid to 100 parts by weight of water) at a temperature of 30° C. for 30 seconds (insolubilization).

Subsequently, the laminate was immersed in a dyeing bath at a temperature of 30° C. while the iodine concentration and the immersion time were so controlled as to allow the resulting polarizing plate to have a predetermined transmittance. In this example, the laminate was immersed for 60 seconds in an aqueous iodine solution obtained by adding 0.2 parts by weight of iodine and 1.0 part by weight of potassium iodide to 100 parts by weight of water (dyeing).

Subsequently, the laminate was immersed for 30 seconds in a crosslinking bath (an aqueous boric acid solution obtained by adding 3 parts by weight of potassium iodide and 3 parts by weight of boric acid to 100 parts by weight of water) at a temperature of 30° C. (crosslinking).

The laminate was then uniaxially stretched to a total stretch ratio of 5.5 times in the longitudinal direction between rolls at different peripheral speeds while it was immersed in an aqueous boric acid solution (an aqueous solution obtained by adding 4 parts by weight of boric acid and 5 parts by weight of potassium iodide to 100 parts by weight of water) at a temperature of 70° C. (in-water stretching).

The laminate was then immersed in a cleaning bath (an aqueous solution obtained by adding 4 parts by weight of potassium iodide to 100 parts by weight of water) at a temperature of 30° C. (cleaning).

The resulting product was an optical film laminate including a 5-μm-thick polarizer.

(Preparation of Polarizers A1 to A7)

Polarizers A1 to A7 were prepared similarly to the preparation of polarizer A0 described above, except that the preparation conditions were changed as shown in Table 1. Table 1 also shows the thicknesses, optical properties (single-body transmittance and polarization degree), and boric acid concentrations of polarizers A1 to A7.

TABLE 1

| | Polarizer | | | | Thickness | Auxiliary | Dyeing bath | |
|---|---|---|---|---|---|---|---|---|
| | | Single-body | Polarization | Boric acid | of PVA type | in-air | | Potassium |
| | Thickness | transmittance T | degree P | content | resin layer | stretch | Iodine content | iodide content |
| | (μm) | (%) | (%) | (% by weight) | (μm) | ratio | (Parts by weight) | (Parts by weight) |
| Polarizer A0 | 5 | 42.8 | 99.99 | 16 | 11 μm | 2.0 times | 0.2 parts | 1.0 parts |
| Polarizer A1 | 7 | 42.8 | 99.99 | 16 | 15 μm | 2.0 times | 0.2 parts | 1.0 parts |
| Polarizer A2 | 3 | 42.8 | 99.99 | 16 | 7 μm | 2.0 times | 0.2 parts | 1.0 parts |
| Polarizer A3 | 5 | 42.8 | 99.99 | 14 | 11 μm | 2.0 times | 0.2 parts | 1.0 parts |
| Polarizer A4 | 5 | 42.8 | 99.99 | 20 | 11 μm | 2.0 times | 0.2 parts | 1.0 parts |
| Polarizer A5 | 5 | 42.8 | 99.99 | 25 | 11 μm | 2.0 times | 0.2 parts | 1.0 parts |
| Polarizer A6 | 5 | 44.1 | 99.99 | 16 | 11 μm | 2.0 times | 0.2 parts | 1.0 parts |
| Polarizer A7 | 5 | 41.5 | 99.99 | 16 | 11 μm | 2.0 times | 0.2 parts | 1.0 parts |

| | | Crosslinking | In-water stretching bath | | | | Cleaning bath |
|---|---|---|---|---|---|---|---|
| | Dyeing bath | bath | | Potassium | | Total | Potassium |
| | Immersion | Boric acid | Boric acid | iodide content | Stretch | stretch | iodide content |
| | time | (Parts by weight) | (Parts by weight) | (Parts by weight) | ratio | ratio | (Parts by weight) |
| Polarizer A0 | 60 seconds | 3.0 parts | 4.0 parts | 5 parts | 2.75 times | 5.5 times | 4 parts |
| Polarizer A1 | 60 seconds | 3.0 parts | 4.0 parts | 5 parts | 2.75 times | 5.5 times | 4 parts |
| Polarizer A2 | 60 seconds | 3.0 parts | 4.0 parts | 5 parts | 2.75 times | 5.5 times | 4 parts |
| Polarizer A3 | 60 seconds | 3.0 parts | 3.5 parts | 5 parts | 2.75 times | 5.5 times | 4 parts |
| Polarizer A4 | 60 seconds | 3.0 parts | 4.5 parts | 5 parts | 2.75 times | 5.5 times | 4 parts |
| Polarizer A5 | 60 seconds | 5.0 parts | 4.5 parts | 5 parts | 2.75 times | 5.5 times | 4 parts |
| Polarizer A6 | 50 seconds | 3.0 parts | 4.0 parts | 5 parts | 2.75 times | 5.5 times | 4 parts |
| Polarizer A7 | 90 seconds | 3.0 parts | 4.0 parts | 5 parts | 2.75 times | 5.5 times | 4 parts |

(Preparation of Transparent Protective Film)

The adhesion facilitation-treated surface of a lactone ring structure-containing (meth)acrylic resin film with a thickness of 40 μm was subjected to a corona treatment. The corona-treated film was used as a transparent protective film.

(Preparation of Adhesive to be Applied to Transparent Protective Film)

An ultraviolet-curable adhesive was prepared by mixing 40 parts by weight of N-hydroxyethylacrylamide (HEAA), 60 parts by weight of acryloylmorpholine (ACMO), and 3 parts by weight of a photo-initiator IRGACURE 819 (manufactured by BASF).

(Preparation of One-Side-Protected Polarizing Films A)

The transparent protective film was bonded to the surface of each of polarizers A0 to A7 of the optical film laminates with the ultraviolet-curable adhesive being applied to the surface in such a manner as to form a 0.5-μm-thick adhesive layer after curing. Subsequently, the adhesive was cured by applying ultraviolet rays as active energy rays. The ultraviolet rays were applied using the following conditions: gallium-containing metal halide lamp; irradiator, Light Hammer 10 manufactured by Fusion UV Systems, Inc; valve, V valve; peak illuminance, 1,600 mW/cm²; total dose, 1,000/mJ/cm² (wavelength 380-440 nm). The illuminance of the ultraviolet rays was measured with Sola-Check System manufactured by Solatell Ltd. Subsequently, the amorphous PET substrate was removed from each product, so that one-side-protected polarizing films A0 to A7 each having the thin polarizer were obtained. Table 3 shows the optical properties (single-body transmittance and polarization degree) of resulting one-side-protected polarizing films A0 to A7.

<One-Side-Protected Polarizing Film B>

(Preparation of Polarizer B (23-μm-Thick Polarizer))

A 75-μm-thick polyvinyl alcohol film with an average degree of polymerization of 2,400 and a degree of saponification of 99.9% by mole was immersed in warm water at 30° C. for 60 seconds so that it was allowed to swell. Subsequently, the film was immersed in an aqueous solution of 0.3% iodine/potassium iodide (0.5/8 in weight ratio) and dyed while stretched to 3.5 times. The film was then stretched to a total stretch ratio of 6 times in an aqueous boric ester solution at 65° C. After the stretching, the film was dried in an oven at 40° C. for 3 minutes to give a PVA-based polarizer (23 μm in thickness).

(Preparation of One-Side-Protected Polarizing Film B)

Similarly to the preparation of one-side-protected polarizing film A, the transparent protective film shown above was bonded to one surface of the PVA-based polarizer with the ultraviolet-curable adhesive shown above. The optical properties of resulting one-side-protected film B were as follows: transmittance 42.8%, polarization degree 99.99%.

<Preparation of One-Side-Protected Polarizing Film C>

(Preparation of Polarizer D (12-μm-Thick Polarizer))

A 30-μm-thick polyvinyl alcohol film with an average degree of polymerization of 2,400 and a degree of saponification of 99.9% by mole was immersed in warm water at 30° C. for 60 seconds so that it was allowed to swell. Subsequently, the film was immersed in an aqueous solution of 0.3% iodine/potassium iodide (0.5/8 in weight ratio) and dyed while stretched to 3.5 times. The film was then stretched to a total stretch ratio of 6 times in an aqueous boric ester solution at 65° C. After the stretching, the film was dried in an oven at 40° C. for 3 minutes to give a PVA-based polarizer. The resulting polarizer was 12 μm in thickness.

(Preparation of One-Side-Protected Polarizing Film C)

Similarly to the preparation of one-side-protected polarizing film A, the transparent protective film shown above was bonded to one surface of the PVA-based polarizer with the ultraviolet-curable adhesive shown above. The optical properties of resulting one-side-protected film C were as follows: transmittance 42.8%, polarization degree 99.99%.

<Formation of Pressure-Sensitive Adhesive Layer>

(Acryl-Based Pressure-Sensitive Adhesive A)

<<Preparation of Acryl-Based Polymer>>

A monomer mixture containing 63 parts of butyl acrylate and 37 parts of methyl methacrylate was charged into a four-necked flask equipped with a stirring blade, a thermometer, a nitrogen gas inlet tube, and a condenser. Further, 0.1 parts of 2,2′-azobisisobutyronitrile as a polymerization initiator was added to 100 parts of the monomer mixture (solid content) together with toluene, and nitrogen gas was introduced while gently stirring under a nitrogen purge. The polymerization reaction was carried out for 7 hours while maintaining the liquid temperature in the flask at around 60° C. Thereafter, toluene was added to the obtained reaction solution so as to have a solid content concentration of 30%, thereby to prepare a solution of an acryl-based polymer having a weight average molecular weight of 100,000.

<<Preparation of Pressure-Sensitive Adhesive Composition>>

One part of a crosslinking agent containing a compound having an isocyanate group as a main component (trade name “Coronate L”, manufactured by Nippon Polyurethane Industry Co., Ltd.) and 0.2 parts of γ-glycidoxypropylmethoxysilane (trade name “KBM-403”, manufactured by Shin-Etsu Chemical Co., Ltd.) were blended with 100 parts (solid content) of the acryl-based polymer solution to prepare a solution of an acryl-based pressure-sensitive adhesive A.

(Acryl-Based Pressure-Sensitive Adhesives B to F)

In the <<Preparation of Acryl-based polymer>> of the acryl-based pressure-sensitive adhesive A, the same operation was carried out except that the composition of the monomer mixture and the solvent were changed as shown in Table 2 to adjust the polymerization conditions, thereby to prepare a solution of an acryl-based polymer having a weight average molecular weight shown in Table 2. Then, the obtained solution of the acryl-based polymer was treated in the same manner as in the <<Preparation of Pressure-Sensitive Adhesive Composition>>, except that the type or blending amount of the crosslinking agent was changed as shown in Table 2, thereby to prepare solutions of acryl-based pressure-sensitive adhesives B to F.

(Formation of Pressure-Sensitive Adhesive Layer)

Next, the acryl-based pressure-sensitive adhesive solution was uniformly applied with a fountain coater to the surface of a polyethylene terephthalate film (separator film) treated with a silicone-type release agent and dried in an air circulation type thermostatic oven at 155° C. for 2 minutes to form a pressure-sensitive adhesive layer on the surface of the separator film. The film thickness of the pressure-sensitive adhesive layer was set as shown in Table 3 when preparing a pressure-sensitive-adhesive-layer-attached one-side-protected polarizing film. Table 2 also shows storage elastic modulus and gel fraction of the pressure-sensitive adhesive layer.

TABLE 2

| | | | | | | | | Weight average |
|---|---|---|---|---|---|---|---|---|
| | | | | | | | | molecular weight |
| | Composition of monomer mixture | | | | | | | of acryl-based |
| Type of pressure- | (parts by weight) | | | | | | | polymer |
| sensitive adhesive | BA | AA | MMA | MA | HBA | ACMO | Solvent | ×10⁴ |
| Pressure-sensitive | 63 | | 37 | | | | Toluene | 10 |
| adhesive A | | | | | | | | |
| Pressure-sensitive | 81 | | 18 | | 1 | | Toluene/ethyl | 30 |
| adhesive B | | | | | | | acetate | |
| Pressure-sensitive | 100 | 3 | | | 0.3 | 7 | Toluene/ethyl | 240 |
| adhesive C | | | | | | | acetate | |
| Pressure-sensitive | 100 | 5 | | | 0.075 | | Toluene/ethyl | 220 |
| adhesive D | | | | | | | acetate | |
| Pressure-sensitive | 99 | | | | 1 | | Ethyl acetate | 160 |
| adhesive E | | | | | | | | |
| Pressure-sensitive | 97.5 | 0.5 | | 1 | 1 | | Ethyl acetate | 160 |
| adhesive F | | | | | | | | |

| | | | | | Physical properties/ | |
|---|---|---|---|---|---|---|
| | Pressure-sensitive | | | | characteristics of | |
| | adhesive composition | | | | pressure-sensitive | |
| | (solution) | | | | adhesive layer | |
| | Crosslinking agent | | Silane coupling agent | | Gel | Storage elastic |
| Type of pressure- | Parts by | | Parts by | | fraction | modulus |
| sensitive adhesive | weight | Type | weight | Type | (%) | (pa) |
| Pressure-sensitive | 1 | Coronate L | 0.2 | KBM-403 | 0 | 8.5E+06 |
| adhesive A | | | | | | |
| Pressure-sensitive | 1 | Coronate L | 0.2 | KBM-403 | 30 | 5.3E+05 |
| adhesive B | | | | | | |
| Pressure-sensitive | 0.2 | Coronate L | 0.2 | KBM-403 | 95 | 1.3E+05 |
| adhesive C | | | | | | |
| Pressure-sensitive | 0.6 | Coronate L | 0.2 | KBM-403 | 80 | 1.1E+05 |
| adhesive D | | | | | | |
| Pressure-sensitive | 0.1 | Takenate | 0.2 | KBM-403 | 80 | 8.1E+04 |
| adhesive E | | D100N | | | | |
| Pressure-sensitive | 0.02 | Takenate | 0.2 | KBM-403 | 45 | 5.4E+04 |
| adhesive F | | D100N | | | | |

Table 2 shows:

BA: Butyl acrylate,

AA: Acrylic acid,

MMA: Methyl methacrylate,

MA: Methyl acrylate,

HBA: 4-Hydroxybutyl (meth)acrylate,

ACMO: N-Acryloyl morpholine,

Toluene/ethyl acetate is a mixed solvent having a volume ratio of 1/1,

Coronate L: Trade name “Coronate L” manufactured by Nippon Polyurethane Industry Co., Ltd., trimethylolpropane/tolylene diisocyanate trimer adduct,

Takenate D110N: Trade name “Takenate D110N”, manufactured by Mitsui Chemical Co., Ltd., trimethylolpropane xylylene diisocyanate, and

KBM-403: γ-Glycidoxypropylmethoxysilane (trade name “KBM-403”, manufactured by Shin-Etsu Chemical Co., Ltd.).

### Examples 1 to 24 and Comparative Examples 1 to 8

<Production of Pressure-Sensitive-Adhesive-Layer-Attached Polarizing Film>

A pressure-sensitive adhesive layer which has a film thickness shown in Table 3 and is formed on the releasing treated surface of the releasing sheet (separator) is laminated on the polarizer side of the one-side-protected polarizing film shown in Table 3 with the pressure-sensitive adhesive shown in Table 3, thereby to prepare a pressure-sensitive-adhesive-layer-attached one-side-protected polarizing film.

The pressure-sensitive-adhesive-layer-attached one-side-protected polarizing films obtained in the examples and comparative examples were evaluated as follows. The results are shown in Table 3. With respect to the relationship between the film thickness and the storage elastic modulus of the pressure-sensitive adhesive layer, Table 3 shows which regions in the graph of FIG. 2 such a relationship belongs to.

<Single-Body Transmittance T and Polarization Degree P of Polarizer>

The single-body transmittance T and polarization degree P of the resulting one-side-protected polarizing films were measured using an integrating sphere-equipped spectral transmittance meter (DOT-3C manufactured by Murakami Color Research Laboratory Co., Ltd.).

The polarization degree P is calculated from the formula below using the transmittance (parallel transmittance Tp) of a laminate of the same two one-side-protected polarizing films with their transmission axes parallel to each other and the transmittance (crossed transmittance Tc) of a laminate of the same two one-side-protected polarizing films with their transmission axes orthogonal to each other.

Polarization degree P(%)={(Tp−Tc)/(Tp+Tc)}^{1/2}×100

Each transmittance was expressed as the Y value, which was obtained through luminosity correction using the two-degree field (illuminant C) according to JIS Z 8701 when the transmittance for completely polarized light obtained through a Glan-Taylor prism polarizer was normalized to 100%.

<Measurement of the Content of Boric Acid in Polarizer>

The polarizers obtained in the examples and the comparative examples were subjected to attenuated total reflection (ATR) spectroscopy using polarized light as the measurement light and using a Fourier transform infrared spectrometer (FTIR) (Spectrum 2000 (trade name) manufactured by PerkinElmer, Inc.), in which the boric acid peak (665 cm⁻¹) intensity and the reference peak (2,941 cm⁻¹) intensity were measured. The boric acid amount index was calculated from the formula below using the resulting boric acid peak intensity and reference peak intensity, and then the boric acid content (% by weight) was determined from the formula below using the calculated boric acid amount index.

(Boric acid amount index)=(the intensity of the boric acid peak at 665 cm⁻¹)/(the intensity of the reference peak at 2,941 cm⁻¹)

(Boric acid content (% by weight))=(boric acid amount index)×5.54+4.1

<Measurement of Storage Elastic Modulus>

The storage elastic modulus at 23° C. was measured using a viscoelasticity spectrometer (trade name: RSA-II) manufactured by Rheometric, Inc. Measurement conditions included a frequency of 1 Hz, a sample thickness of 2 mm, a contact bonding load of 100 g, and a temperature elevation rate of 5° C./min, and a value obtained at 23° C. in a range of −50° C. to 200° C. was employed as a measurement value.

<Gel Fraction>

Each acryl-based pressure-sensitive adhesive composition obtained in examples and comparative examples was treated under the same drying conditions (temperature and time) as in each of examples and comparative examples to form a pressure-sensitive adhesive layer, which was allowed to stand at a temperature of 23° C. and a humidity of 65% RH for 5 days. Then, 0.2 g of the pressure-sensitive adhesive layer was taken out and wrapped by a fluororesin film (TEMISH NTF-1122, manufactured by Nitto Denko Corp.) (weight: Wa) the weight of which was measured in advance. Then, the fluororesin film was tied so as to prevent leakage of the acryl-based pressure-sensitive adhesive composition. This was served as a measurement sample. The weight of the measurement sample was measured (weight: Wb) and placed in a sample bottle. Ethyl acetate (40 cc) was added to the sample bottle and the sample was allowed to stand for 7 days. Thereafter, the measurement sample (fluororesin film+acryl-based pressure-sensitive adhesive composition) was taken out and dried on an aluminum cup at 130° C. for 2 hours. The weight (Wc) of the measurement sample was measured and the gel fraction was determined by the following equation.

$$Gel fraction ( percent by weight ) = \frac{( Wc - Wa )}{( Wb - Wa )} \times 100 \qquad [ Equation 1 ]$$

<Observation of Through Cracks (Heat Shock Test)>

A piece of 50 mm×150 mm (50 mm in the absorption axis direction) and a piece of 150 mm×50 mm (150 mm in the absorption axis direction) were cut from each resulting pressure-sensitive-adhesive-layer-attached one-side-protected polarizing film. The cut pieces were bonded in the directions of crossed Nicols to both sides a 0.5-mm-thick non-alkali glass sheet to form a sample. The sample was exposed to the environment of 300 cycles of heat shock from −40 to 85° C. each for 30 minutes. Subsequently, the sample was taken out and visually observed for the presence or absence of through cracks (and the number of through cracks) in the pressure-sensitive-adhesive-layer-attached one-side-protected polarizing film. This test was performed five times. The evaluation was performed according to the following.

◯: No through crack is observed.

x: A through crack or cracks are observed.

FIG. 5 is an exemplary micrograph of the polarizing film surface, which provides a measure for identifying a through crack b in the pressure-sensitive-adhesive-layer-attached one-side-protected polarizing film 11. FIG. 5 was obtained by observing the sample suffering from a through crack using a differential interference microscope.

<Suppression of the Occurrence of Nano-Slits (Guitar Pick Test)>

A piece with a size of 50 mm×150 mm (50 mm in the absorption axis direction) was cut from the resulting pressure-sensitive-adhesive-layer-attached one-side-protected polarizing film. The resulting piece was called sample 11. When sample 11 used, surface protective film 6 prepared by the method described below was bonded to the protective film 2 side of sample 11.

(Surface Protective Film for Test)

A backing-forming material of low-density polyethylene with a melt flow rate of 2.0 g/10 min at 190° C. and a density of 0.924 g/cm³ was supplied to an inflation molding machine for co-extrusion.

At the same time, a pressure-sensitive adhesive-forming material of a propylene-butene copolymer (propylene:butene=85:15 in weight ratio, atactic structure) with a melt flow rate of 10.0 g/10 min at 230° C. and a density of 0.86 g/cm³ was supplied to the inflation molding machine with a die temperature of 220° C. and subjected to co-extrusion. A surface protective film composed of a 33-μm-thick backing layer and a 5-μm-thick pressure-sensitive adhesive layer was produced in this way.

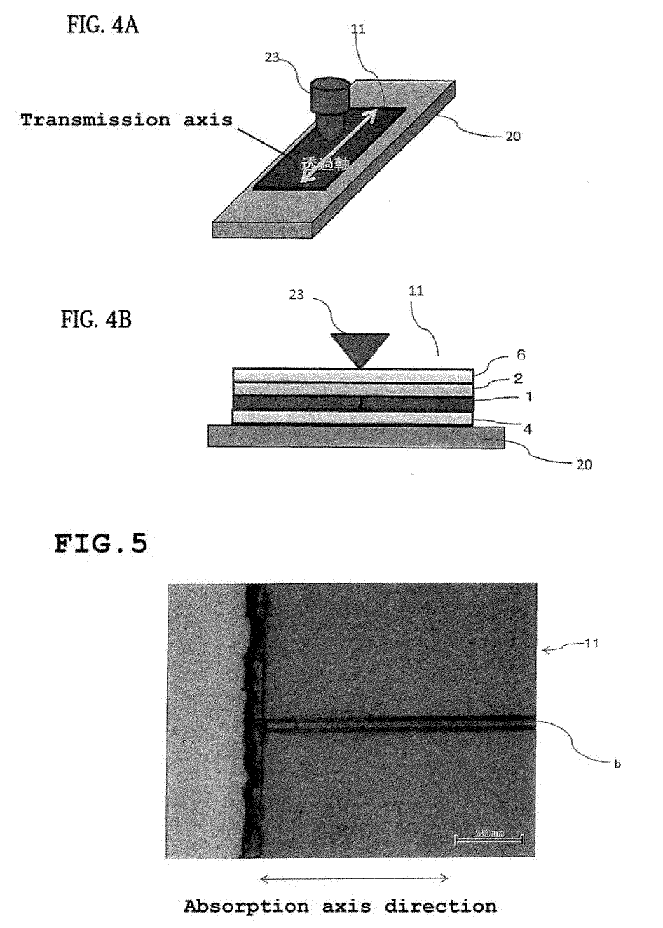

Next, as shown in the conceptual view of FIG. 4(A) and the cross-sectional view of FIG. 4(B), the release sheet (separator) was peeled off from the sample, and the sample was pasted on a glass plate 20 via an exposed pressure-sensitive adhesive layer 4. Subsequently, a load of 200 g was applied using a guitar pick (Model No. HP2H (HARD) manufactured by HISTORY, Inc.) to the center of sample 11 (surface protective film 6 side), and the applied load was reciprocated 50 times within a distance of 100 mm in the direction perpendicular to the absorption axis of polarizer 1 of sample 11. The load was applied to one portion.

Subsequently, after sample 11 was allowed to stand in an environment at 80° C. for 1 hour, it was evaluated whether light leakage cracks occurred in sample 11, based on the following criteria.

⊙: 0 to 30 cracks

◯: 31 to 200 cracks

Δ: 201 to 800 cracks

x: 801 or more cracks

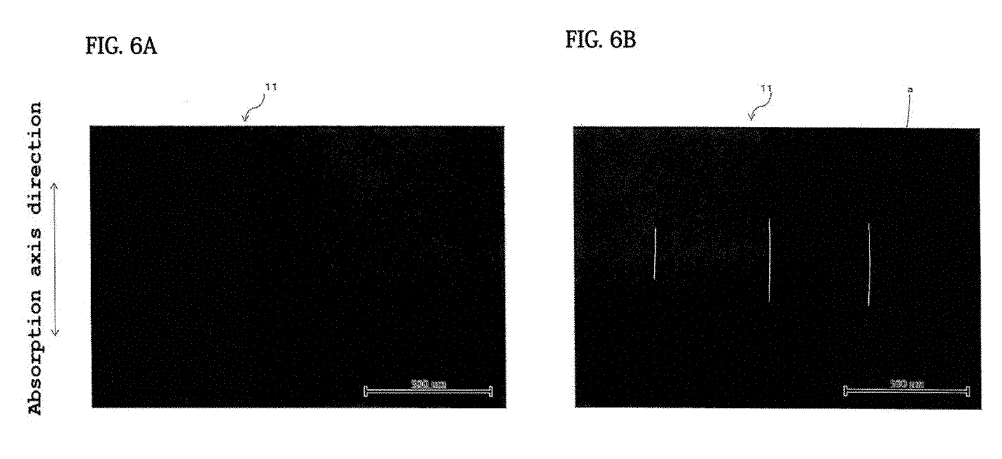

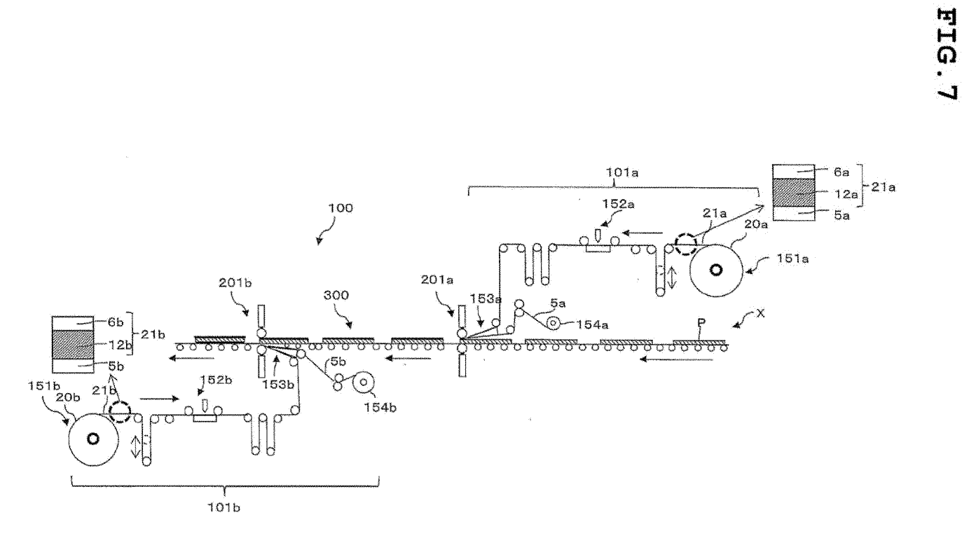

FIG. 6 is an example of a microscopic photograph of the surface of the polarizing film, which is an indicator of confirmation of light leakage crack (nano-slit a) in the guitar pick test of the one-side-protected polarizing film 11. In FIG. 6(A), any light leakage crack due to nano-slit a has not been confirmed. On the other hand, FIG. 6(B) shows a case where three light leakage cracks due to nano-slit a are generated in the absorption axis direction of the polarizer by heating. The state as shown in FIG. 6(B) corresponds to the state after heating in the guitar pick test of comparative example. In FIG. 6, a sample in which nano-slits occurred was observed with a differential interference microscope. When photographing the sample, a sample in which nano-slit did not occur was set so as to be in a crossed nicol state on the lower side (transmitting light source side) of the sample in which nano-slits occurred and was observed with transmitted light.

TABLE 3

| | | | | | | | | | | Evaluation | | |
|---|---|---|---|---|---|---|---|---|---|---|---|---|
| | | | | | | | | | | | Suppression of | |
| | One-side-protected polarizing film | | | | | | | | | | occurrence of nano- | |
| | | Polarizer | | | | | | | | | slits: guitar pick test | |
| | | | Single- | | Boric | Pressure-sensitive adhesive layer | | | | | Number | |
| | | | body | Polari- | acid | Type of | | Storage | Existence | Confirmation | of light | |
| | | Thick- | transmit- | zation | content | pressure- | Thick- | elastic | region in | of through | leakage | |
| | | ness | tance | degree P | (% by | sensitive | ness | modulus | the graph | cracks: heat | cracks | Judg- |
| | Type | (μm) | T (%) | (%) | weight) | adhesive | (μm) | (pa) | of FIG. 2 | shock test | (number) | ment |
| Example 1 | A1 | 7 | 42.8 | 99.99 | 16 | Pressure- | 40 | 8.5E+06 | (2) | ◯ | 85 | ◯ |
| | | | | | | sensitive | | | | | | |
| | | | | | | adhesive A | | | | | | |
| Example 2 | A1 | 7 | 42.8 | 99.99 | 16 | Pressure- | 30 | 8.5E+06 | (1) | ◯ | 10 | ⊙ |
| | | | | | | sensitive | | | | | | |
| | | | | | | adhesive A | | | | | | |
| Example 3 | A1 | 7 | 42.8 | 99.99 | 16 | Pressure- | 20 | 8.5E+06 | (1) | ◯ | 0 | ⊙ |
| | | | | | | sensitive | | | | | | |
| | | | | | | adhesive A | | | | | | |
| Example 4 | A1 | 7 | 42.8 | 99.99 | 16 | Pressure- | 10 | 8.5E+06 | (1) | ◯ | 0 | ⊙ |
| | | | | | | sensitive | | | | | | |
| | | | | | | adhesive A | | | | | | |
| Example 5 | A0 | 5 | 42.8 | 99.99 | 16 | Pressure- | 35 | 5.3E+05 | (3) | ◯ | 300 | Δ |
| | | | | | | sensitive | | | | | | |
| | | | | | | adhesive B | | | | | | |
| Example 6 | A0 | 5 | 42.8 | 99.99 | 16 | Pressure- | 30 | 5.3E+05 | (2) | ◯ | 151 | ◯ |
| | | | | | | sensitive | | | | | | |
| | | | | | | adhesive B | | | | | | |
| Example 7 | A0 | 5 | 42.8 | 99.99 | 16 | Pressure- | 20 | 5.3E+05 | (1) | ◯ | 20 | ⊙ |
| | | | | | | sensitive | | | | | | |
| | | | | | | adhesive B | | | | | | |
| Example 8 | A0 | 5 | 42.8 | 99.99 | 16 | Pressure- | 20 | 1.3E+05 | (2) | ◯ | 127 | ◯ |
| | | | | | | sensitive | | | | | | |
| | | | | | | adhesive C | | | | | | |
| Example 9 | A0 | 5 | 42.8 | 99.99 | 16 | Pressure- | 15 | 1.3E+05 | (1) | ◯ | 18 | ⊙ |
| | | | | | | sensitive | | | | | | |
| | | | | | | adhesive C | | | | | | |
| Example 10 | A0 | 5 | 42.8 | 99.99 | 16 | Pressure- | 10 | 1.3E+05 | (1) | ◯ | 0 | ⊙ |
| | | | | | | sensitive | | | | | | |
| | | | | | | adhesive C | | | | | | |
| Example 11 | A0 | 5 | 42.8 | 99.99 | 16 | Pressure- | 5 | 1.3E+05 | (1) | ◯ | 0 | ⊙ |
| | | | | | | sensitive | | | | | | |
| | | | | | | adhesive C | | | | | | |
| Example 12 | A0 | 5 | 42.8 | 99.99 | 16 | Pressure- | 23 | 1.1E+05 | (3) | ◯ | 786 | Δ |
| | | | | | | sensitive | | | | | | |
| | | | | | | adhesive D | | | | | | |
| Example 13 | A0 | 5 | 42.8 | 99.99 | 16 | Pressure- | 15 | 1.1E+05 | (2) | ◯ | 129 | ◯ |
| | | | | | | sensitive | | | | | | |
| | | | | | | adhesive D | | | | | | |
| Example 14 | A0 | 5 | 42.8 | 99.99 | 18 | Pressure- | 10 | 1.1E+05 | (1) | ◯ | 2 | ⊙ |
| | | | | | | sensitive | | | | | | |
| | | | | | | adhesive D | | | | | | |
| Example 15 | A0 | 5 | 42.8 | 99.99 | 16 | Pressure- | 5 | 1.1E+05 | (1) | ◯ | 0 | ⊙ |
| | | | | | | sensitive | | | | | | |
| | | | | | | adhesive D | | | | | | |
| Example 16 | A0 | 5 | 42.8 | 99.99 | 16 | Pressure- | 15 | 8.1E+04 | (3) | ◯ | 690 | Δ |
| | | | | | | sensitive | | | | | | |
| | | | | | | adhesive E | | | | | | |
| Example 17 | A0 | 5 | 42.8 | 99.99 | 16 | Pressure- | 13 | 8.1E+04 | (3) | ◯ | 451 | Δ |
| | | | | | | sensitive | | | | | | |
| | | | | | | adhesive E | | | | | | |
| Example 18 | A0 | 5 | 42.8 | 99.99 | 16 | Pressure- | 8 | 8.1E+04 | (2) | ◯ | 45 | ◯ |
| | | | | | | sensitive | | | | | | |
| | | | | | | adhesive E | | | | | | |
| Example 19 | A0 | 5 | 42.8 | 99.99 | 16 | Pressure- | 7 | 5.4E+04 | (3) | ◯ | 300 | Δ |
| | | | | | | sensitive | | | | | | |
| | | | | | | adhesive F | | | | | | |
| Example 20 | A2 | 3 | 42.8 | 99.99 | 16 | Pressure- | 20 | 8.5E+06 | (1) | ◯ | 0 | ⊙ |
| | | | | | | sensitive | | | | | | |
| | | | | | | adhesive A | | | | | | |
| Example 21 | A3 | 5 | 42.8 | 99.99 | 14 | Pressure- | 20 | 1.3E+05 | (2) | ◯ | 48 | ◯ |
| | | | | | | sensitive | | | | | | |
| | | | | | | adhesive C | | | | | | |
| Example 22 | A4 | 5 | 42.8 | 99.99 | 20 | Pressure- | 20 | 1.3E+05 | (2) | ◯ | 155 | ◯ |
| | | | | | | sensitive | | | | | | |
| | | | | | | adhesive C | | | | | | |
| Example 23 | A6 | 5 | 44.1 | 99.99 | 16 | Pressure- | 10 | 8.5E+06 | (1) | ◯ | 0 | ⊙ |
| | | | | | | sensitive | | | | | | |
| | | | | | | adhesive A | | | | | | |
| Example 24 | A7 | 5 | 41.5 | 99.99 | 16 | Pressure- | 10 | 8.5E+06 | (1) | ◯ | 0 | ⊙ |
| | | | | | | sensitive | | | | | | |
| | | | | | | adhesive A | | | | | | |
| Comparative | A0 | 5 | 42.8 | 99.99 | 16 | Pressure- | 40 | 5.3E+05 | (4) | ◯ | 1200 | X |
| example 1 | | | | | | sensitive | | | | | | |
| | | | | | | adhesive B | | | | | | |
| Comparative | A0 | 5 | 42.8 | 99.99 | 16 | Pressure- | 23 | 8.1E+04 | (4) | ◯ | 1500 | X |
| example 2 | | | | | | sensitive | | | | | | |
| | | | | | | adhesive E | | | | | | |
| Comparative | A0 | 5 | 42.8 | 99.99 | 16 | Pressure- | 20 | 8.1E+04 | (4) | ◯ | 1200 | X |
| example 3 | | | | | | sensitive | | | | | | |
| | | | | | | adhesive E | | | | | | |
| Comparative | A0 | 5 | 42.8 | 99.99 | 16 | Pressure- | 20 | 5.4E+04 | (4) | ◯ | 1800 | X |
| example 4 | | | | | | sensitive | | | | | | |
| | | | | | | adhesive F | | | | | | |
| Comparative | A0 | 5 | 42.9 | 99.99 | 16 | Pressure- | 15 | 5.4E+04 | (4) | ◯ | 1200 | X |
| example 5 | | | | | | sensitive | | | | | | |
| | | | | | | adhesive F | | | | | | |
| Comparative | B | 23 | 42.8 | 99.99 | 16 | Pressure- | 10 | 8.5E+06 | (1) | X | 0 | ⊙ |
| example 6 | | | | | | sensitive | | | | | | |
| | | | | | | adhesive A | | | | | | |
| Comparative | A5 | 5 | 42.8 | 99.99 | 25 | Pressure- | 20 | 1.3E+05 | (2) | X | 1000 | X |
| example 7 | | | | | | sensitive | | | | | | |
| | | | | | | adhesive C | | | | | | |
| Comparative | C | 12 | 42.8 | 99.99 | 16 | Pressure- | 10 | 8.5E+06 | (1) | X | 0 | ⊙ |
| example 8 | | | | | | sensitive | | | | | | |
| | | | | | | adhesive A | | | | | | |

### Example 25

This example is similar to Example 10, except that one-side-protected polarizing film was used in the form of a long strip, the forming material was applied using a micro gravure coater, and the release sheet (separator) and the surface protective film described below were used in the form of long strips. In this way, there was prepared a roll of a pressure-sensitive-adhesive-layer-attached one-side-protected polarizing film (embodiment of FIG. 1), wherein the separator placed on the polarizer side of the one-side-protected polarizing film and the surface protective film placed on the transparent protective film side were laminated. A set of rolls of the pressure-sensitive-adhesive-layer-attached one-side-protected polarizing film were provided having widths corresponding to the short and long sides of a 32-inch non-alkali glass sheet, respectively, in order to be subjected to slit processing, in which the pressure-sensitive-adhesive-layer-attached one-side-protected polarizing film was cut into pieces while being fed continuously.

(Surface Protective Film for Roll-to-Panel Process)

A surface protective film was obtained by applying an acrylic pressure-sensitive adhesive with a thickness of 15 μm to the surface of an antistatic treatment layer-attached polyethylene terephthalate film (Diafoil T100G38 (trade name) manufactured by Mitsubishi Plastics, Inc., 38 μm in thickness) opposite to its antistatically treated surface.

Using a continuous production system for the roll-to-panel process shown in FIG. 7, the pressure-sensitive-adhesive-layer-attached one-side-protected polarizing films were continuously supplied from the set of rolls, and the pressure-sensitive-adhesive-layer-attached one-side-protected polarizing films were continuously bonded in a cross-Nicols relationship to both sides of each of 100 sheets of 0.5-mm-thick 32-inch non-alkali glass.

<Observation of Occurrence of Nano-Slits (Heating Test)>

A hundred sheets of non-alkali glass each provided with the pressure-sensitive-adhesive-layer-attached one-side-protected polarizing films bonded to both sides were placed in an oven at 80° C. for 24 hours and then visually observed for the presence or absence of nano-slits. No nano-slit-induced defect (light leakage) was observed.

### DESCRIPTION OF REFERENCE SIGNS

1 Polarizer
2 Protective film
3 Adhesive layer and the like
4 Pressure-sensitive adhesive layer
5, 5a, 5b Separator
6, 6a, 6b Surface protective film
10 One-side-protected polarizing film
11 Pressure-sensitive-adhesive-layer-attached one-side-protected polarizing film
20a, 20b Roll of pressure-sensitive-adhesive-layer-attached one-side-protected polarizing film (roll)
21a, 21b
Pressure-sensitive-adhesive-layer-attached one-side-protected polarizing film (with surface protective film)
100 System for continuously producing image display devices
101a, 101b Polarizing film supply unit
151a, 151b Unwinding unit
152a, 152b Cutting unit
153a, 153b Peeling unit
154a, 154b Winding unit
201a, 201b Bonding unit
300 Orientation changing unit
P Image display panel
X Image display panel feed unit

1. A pressure-sensitive-adhesive-layer-attached one-side-protected polarizing film, which comprises a one-side-protected polarizing film having a protective film on only one side of a polarizer, and a pressure-sensitive adhesive layer on the polarizer side of the one-side-protected polarizing film, wherein
the polarizer comprises a polyvinyl alcohol-based resin, comprises 20% by weight or less of boric acid relative to a total quantity of the polarizer, has a thickness of 10 μm or less, and is designed to have a single-body transmittance T and a polarization degree P representing optical properties satisfying the condition of the following formula: P>−(10^{0.929T-42.4}−1)×100 (provided that T<42.3) or P≥99.9 (provided that T≥42.3),
a film thickness of the pressure-sensitive adhesive layer is less than 50 μm, and if a storage elastic modulus of the pressure-sensitive adhesive layer at 23° C. is termed G (Pa) and a film thickness of the pressure-sensitive adhesive layer is termed H (μm), G>210e^{0.2035H} is satisfied when 50>H≥32, and G>35000e^{0.0433H} is satisfied when 32>H>0.

2. The pressure-sensitive-adhesive-layer-attached one-side-protected polarizing film according to claim 1, wherein the film thickness H (μm) satisfies 32>H>0 and the storage elastic modulus G (Pa) satisfies G>35000e^{0.0433H}.

3. The pressure-sensitive-adhesive-layer-attached one-side-protected polarizing film according to claim 1, wherein the pressure-sensitive adhesive layer has a storage elastic modulus of 3.5×10⁴ Pa or more.

4. The pressure-sensitive-adhesive-layer-attached one-side-protected polarizing film according to claim 1, further comprising a separator provided on the pressure-sensitive adhesive layer.

5. The pressure-sensitive-adhesive-layer-attached one-side-protected polarizing film according to claim 4, which is in the form of a roll.

6. An image display device comprising the pressure-sensitive-adhesive-layer-attached one-side-protected polarizing film according to claim 1.

7. A method for continuously producing an image display device, the method comprising the steps of:
unwinding the pressure-sensitive-adhesive-layer-attached one-side-protected polarizing film from the roll of the pressure-sensitive-adhesive-layer-attached one-side-protected polarizing film according to claim 5;
feeding the pressure-sensitive-adhesive-layer-attached one-side-protected polarizing film with the separator; and
continuously bonding the pressure-sensitive-adhesive-layer-attached one-side-protected polarizing film to a surface of an image display panel with the pressure-sensitive adhesive layer interposed therebetween.

8. The pressure-sensitive-adhesive-layer-attached one-side-protected polarizing film according to claim 2, wherein the pressure-sensitive adhesive layer has a storage elastic modulus of 3.5×10⁴ Pa or more.

9. The pressure-sensitive-adhesive-layer-attached one-side-protected polarizing film according to claim 2, further comprising a separator provided on the pressure-sensitive adhesive layer.

10. The pressure-sensitive-adhesive-layer-attached one-side-protected polarizing film according to claim 3, further comprising a separator provided on the pressure-sensitive adhesive layer.

11. An image display device comprising the pressure-sensitive-adhesive-layer-attached one-side-protected polarizing film according to claim 2.

12. An image display device comprising the pressure-sensitive-adhesive-layer-attached one-side-protected polarizing film according to claim 3.
